(19) United States
(12) Patent Application Publication
(10) Pub. No.: US 2017/0286164 A1
(43) Pub. Date: Oct. 5, 2017

(54) MANAGEMENT SERVER, COMMUNICATION SYSTEM, NETWORK MANAGEMENT METHOD, AND NON-TRANSITORY COMPUTER READABLE MEDIUM STORING PROGRAM

(71) Applicant: NEC Corporation, Tokyo (JP)

(72) Inventor: Shingo KINOSHITA, Tokyo (JP)

(21) Appl. No.: 15/514,034

(22) PCT Filed: Mar. 10, 2015
(86) PCT No.: PCT/JP2015/001286

§ 371 Date: Mar. 24, 2017

(30) Foreign Application Priority Data
Sep. 25, 2014 (JP) 2014-194985

(51) Int. Cl. H04L 12/28

(52) U.S. Cl. CPC G06F 9/50; H04L 2012/5667

(57) ABSTRACT

A management server capable of allocating a network parameter desired by a user to a communication device corresponding to a node constituting a network structure that has been constructed in advance in a simpler way is provided. A management server (20) includes a management unit (22), a reception unit (24), and an update unit (26). The management unit (22) manages network information indicating a network structure composed of a plurality of nodes, network parameters associated with the plurality of respective nodes in advance, and apparatus identification information of communication apparatuses corresponding to the plurality of respective nodes. The reception unit (24) receives, from a communication apparatus (10-2) corresponding to a second node, a change notification indicating that a communication apparatus (10-1) corresponding to a first node has been changed. The update unit (26) updates information regarding the first node in the network information using the change notification.

### TECHNICAL FIELD

The present invention relates to a management server, a communication system, a network management method, and a non-transitory computer readable medium storing a program, and more specifically, to a management server, a communication system, a network management method, and a non-transitory computer readable medium storing a program that manage a network composed of a plurality of nodes.

### BACKGROUND ART

Construction for installing a communication apparatus such as construction for, in accordance with aging of a communication apparatus that constitutes a network, replacing the aged communication apparatus by another communication apparatus or that for adding a new communication apparatus in a position where no communication apparatus has been installed, is carried out. When this construction is carried out, it is required to allocate an IP address or the like, which is a network parameter, to the communication apparatus after the replacement and to the communication apparatus that has been newly installed in order to achieve a network communication. Since it takes time and trouble for a user to manually allocate the IP address, it is desirable that the allocation of the IP address be automatically performed independently of a user's operation.

As a technique for automatically allocating the IP address, for example, there is a method of using a Dynamic Host Configuration Protocol (DHCP) server. Typically, the DHCP server randomly selects an IP address that is not used from an IP address group (an IP address pool) that is set on the side of the DHCP server in advance and allocates (gives out) the IP address that has been selected to the communication apparatus that has been newly installed. The DHCP server allocates a specific IP address to a specific communication apparatus for a predetermined lease period. However, when the lease period expires, another IP address may be allocated to this communication apparatus. In order to solve this problem, there is a method of using a Media Access Control (MAC) address of the communication apparatus in order to cause the specific IP address to be allocated to the specific communication apparatus. The DHCP server allocates the specific IP address to the communication apparatus of the specific MAC address by associating the MAC address with the IP address in advance.

With regard to the aforementioned technique, Patent Literature 1 discloses an automatic address allocation apparatus capable of automatically allocating and deleting addresses and improving the working efficiency of maintenance personnel. The automatic address allocation apparatus disclosed in Patent Literature 1 allocates, every time a link with a microwave radio communication apparatus (slave station) other than a microwave radio communication apparatus that is set as a master station is established, an address to the microwave radio communication apparatus in which the link has been established using a DHCP function.

Further, Patent Literature 2 discloses a server that appropriately manages a communication apparatus based on a position in which the communication apparatus is installed and a method of allocating an IP address in the server. The server disclosed in Patent Literature 2 includes a storage unit that stores an IP address allocated to the communication apparatus in association with positional information regarding the position in which the communication apparatus is installed, and a controller that allocates, when the controller receives a request for allocating the IP address from the communication apparatus, the IP address to the communication apparatus based on the positional information of the communication apparatus and the positional information stored in the storage unit.

Further, Patent Literature 3 discloses an IP address delivery system and an IP address delivery method capable of automatically delivering, when one terminal apparatus is replaced by another terminal apparatus on a communication network, an IP address the same as the IP address used in the terminal apparatus before the replacement. The IP address delivery system according to Patent Literature 3 includes an IP address delivery apparatus including a path information reading unit configured to read, from an IP address request signal, path information of a communication network extending to a request source of an IP address, an IP address correspondence table in which a correspondence between the path information and the IP address is registered, and an IP address determining unit configured to determine, based on the path information obtained from the path information reading unit and the IP address correspondence table, an IP address delivered to the request source, and a path information granting unit configured to grant the path information to the IP address request signal.

### CITATION LIST

### Patent Literature

[Patent Literature 1] Japanese Unexamined Patent Application Publication No. 2008-270946
[Patent Literature 2] Japanese Unexamined Patent Application Publication No. 2012-191263
[Patent Literature 3] International Patent Publication No. WO 2011/074123

### SUMMARY OF INVENTION

### Technical Problem

When a network composed of a plurality of communication apparatuses is constructed, a user may construct a network structure in advance and the communication apparatuses may be arranged in accordance with the network structure that has been constructed in advance. In this case, IP addresses are allocated to the respective communication apparatuses that constitute the network structure. In such a case, even when a communication apparatus is replaced by another communication apparatus, it is desirable that the IP address that has been allocated to the communication apparatus before the replacement be allocated to the communication apparatus after the replacement. Further, when a new communication apparatus is installed, it is desirable that the IP address desired by the user be allocated to the communication apparatus that is newly installed. Specifically, the user may desire that a specific IP address be allocated to the communication apparatus installed in a specific position on the network structure constructed in advance.

On the other hand, since the MAC address is uniquely determined for each communication apparatus, when a communication apparatus is replaced by another communication apparatus, the MAC address is changed as well. Accordingly, according to the aforementioned method in which the MAC address and the IP address are associated with each other in advance in the DHCP server, the IP address that has been allocated to the communication apparatus before the replacement may not be allocated to the communication apparatus after the replacement.

Further, in the aforementioned Patent Literature 1, the master station allocates an IP address that is available among the IP addresses that the master station can allocate. Accordingly, it is possible that the IP address that is not desired by the user may be allocated to the communication apparatus.

Further, in the aforementioned Patent Literature 2, the IP address is allocated to the communication apparatus using the positional information acquired by the communication apparatus. That is, the communication apparatus needs to acquire the positional information of the communication apparatus. Accordingly, when the communication apparatus that constitutes the network cannot acquire the positional information, the IP address desired by the user may not be allocated to the communication apparatus.

Further, the aforementioned Patent Literature 3 requires processing for granting, by the path information granting unit in a switch unit connected to each of the terminal apparatuses, the path information to the IP address request signal. This processing involves special processing such as packet analysis for a signal from the terminal apparatus. Accordingly, the processing in the switch unit becomes complicated. Further, it is not assumed in Patent Literature 3 that the network structure is changed. Therefore, when a new terminal apparatus is installed, the IP address desired by the user may not be allocated to the communication apparatus.

The present invention has been made to solve the aforementioned problems and aims to provide a management server, a communication system, a network management method, and a non-transitory computer readable medium storing a program capable of allocating a network parameter desired by a user to a communication apparatus corresponding to a node that constitutes a network structure constructed in advance in a simpler way.

### Solution to Problem

A management server according to the present invention includes: management means for managing network information indicating a network structure composed of a plurality of nodes, network parameters associated with the plurality of respective nodes in advance, and apparatus identification information that identifies communication apparatuses corresponding to the plurality of respective nodes; reception means for receiving, from a second communication apparatus, a change notification indicating that a first communication apparatus corresponding to a first node among the plurality of nodes has been changed, the second communication apparatus corresponding to a second node that is adjacent to the first node; and update means for updating information regarding the first node in the network information using the change notification.

Further, another management server according to the present invention includes: management means for managing network information indicating a network structure composed of a plurality of nodes, network parameters associated with the plurality of respective nodes in advance, and apparatus identification information that identifies communication apparatuses corresponding to the plurality of respective nodes; and display means for displaying the network information.

Further, another management server according to the present invention is a management server that manages a network, the management server including detection means for detecting that a communication apparatus that constitutes the network has been replaced by another communication apparatus; and association means for associating a network parameter that has been associated with the communication apparatus before the replacement with the communication apparatus after the replacement.

Further, a communication system according to the present invention includes: a plurality of communication apparatuses; and a management server that manages a network composed of the plurality of communication apparatuses, in which the management server includes: management means for managing network information indicating a network structure composed of a plurality of nodes, network parameters associated with the plurality of respective nodes in advance, and apparatus identification information that identifies communication apparatuses corresponding to the plurality of respective nodes; reception means for receiving, from a second communication apparatus among the plurality of communication apparatuses, a change notification indicating that a first communication apparatus among the plurality of communication apparatuses corresponding to a first node among the plurality of nodes has been changed, the second communication apparatus corresponding to a second node adjacent to the first node; and update means for updating information regarding the first node in the network information using the change notification.

Further, a network management method according to the present invention includes: managing network information indicating a network structure composed of a plurality of nodes, network parameters associated with the plurality of respective nodes in advance, and apparatus identification information that identifies communication apparatuses corresponding to the plurality of respective nodes; receiving, from a second communication apparatus, a change notification indicating that a first communication apparatus corresponding to a first node among the plurality of nodes has been changed, the second communication apparatus corresponding to a second node that is adjacent to the first node; and updating information regarding the first node in the network information using the change notification.

Further, a program according to the present invention causes a computer to achieve the following functions of: managing network information indicating a network structure composed of a plurality of nodes, network parameters associated with the plurality of respective nodes in advance, and apparatus identification information that identifies communication apparatuses corresponding to the plurality of respective nodes; receiving, from a second communication apparatus, a change notification indicating that a first communication apparatus corresponding to a first node among the plurality of nodes has been changed, the second communication apparatus corresponding to a second node that is adjacent to the first node; and updating information regarding the first node in the network information using the change notification.

### Advantageous Effects of Invention

According to the present invention, it is possible to provide a management server, a communication system, a network management method, and a non-transitory computer readable medium storing a program capable of allocating a network parameter desired by a user to a communication apparatus corresponding to a node that constitutes a network structure constructed in advance in a simpler way.

### BRIEF DESCRIPTION OF DRAWINGS

FIG. 1 is a diagram showing the outline of a communication system according to exemplary embodiments of the present invention;

FIG. 2 is a diagram showing a communication system according to a first exemplary embodiment;

FIG. 3A is a diagram illustrating information transmitted in the communication system according to the first exemplary embodiment;

FIG. 3B is a diagram illustrating information transmitted in the communication system according to the first exemplary embodiment;

FIG. 4 is a functional block diagram of an NMS server according to the first exemplary embodiment;

FIG. 5 is a diagram illustrating a network table according to the first exemplary embodiment;

FIG. 6 is a diagram illustrating a network map according to the first exemplary embodiment;

FIG. 7 is a functional block diagram of a DHCP server according to the first exemplary embodiment;

FIG. 8 is a diagram illustrating allocation information stored in an allocation information storage unit of a DHCP server according to the first exemplary embodiment;

FIG. 9 is a sequence diagram showing a process flow in the communication system when one communication apparatus is deleted in the first exemplary embodiment;

FIG. 10 is a diagram schematically showing a state in which one communication apparatus is deleted in the first exemplary embodiment;

FIG. 11A is a diagram illustrating a network table in the examples of FIGS. 9 and 10;

FIG. 11B is a diagram illustrating allocation information in the examples of FIGS. 9 and 10;

FIG. 12 is a diagram illustrating a network map in the examples of FIGS. 9 and 10;

FIG. 13 is a sequence diagram showing a process flow in the communication system when another communication apparatus is installed in the position of the communication apparatus that has been deleted in FIG. 9;

FIG. 14 is a diagram schematically showing a state in which another communication apparatus is installed in the position of the communication apparatus that has been deleted in FIG. 9;

FIG. 15A is a diagram illustrating a network table in the examples of FIGS. 13 and 14;

FIG. 15B is a diagram illustrating allocation information in the examples of FIGS. 13 and 14;

FIG. 16 is a diagram illustrating a network map in the examples of FIGS. 13 and 14;

FIG. 17 is a sequence diagram showing a process flow to allocate an IP address to the communication apparatus that has been added in FIG. 13;

FIG. 18 is a diagram schematically showing a state in which the IP address is allocated to the communication apparatus that has been added in FIG. 13;

FIG. 19 is a diagram illustrating a network table in the examples of FIGS. 17 and 18;

FIG. 20 is a sequence diagram showing a process flow in the communication system when one communication apparatus is newly installed in the first exemplary embodiment;

FIG. 21 is a diagram schematically showing a state in which one communication apparatus is newly installed in the first exemplary embodiment;

FIG. 22A is a diagram illustrating a network table in the examples of FIGS. 20 and 21;

FIG. 22B is a diagram illustrating allocation information in the examples of FIGS. 20 and 21; and

FIG. 23 is a diagram illustrating a network map in the examples of FIGS. 20 and 21.

### DESCRIPTION OF EMBODIMENTS

### Outline of Exemplary Embodiments According to Present Invention

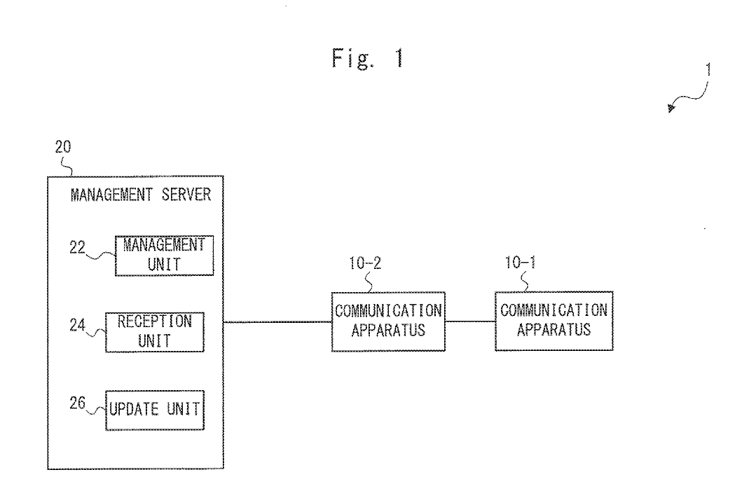

Prior to giving the description of exemplary embodiments of the present invention, with reference to FIG. 1, the outline of the exemplary embodiments of the present invention will be described. FIG. 1 is a diagram showing the outline of a communication system 1 according to the exemplary embodiments of the present invention. As shown in FIG. 1, the communication system 1 includes a plurality of communication apparatuses 10-1 and 10-2 and a management server 20. The number of the plurality of communication apparatuses 10-1 and 10-2 may be other than two. In the following description, the communication apparatuses 10-1 and 10-2 are collectively referred to as a communication apparatus 10.

The communication apparatus 10-1 (a first communication apparatus) and the communication apparatus 10-2 (a second communication apparatus) are adjacent to each other and communicatively connected to each other in a wired or wireless manner. The communication apparatus 10-2 is communicatively connected to the management server 20. The communication apparatus 10-2 may not be directly connected to the management server 20 and may instead communicate with the management server 20 via another communication apparatus 10.

The management server 20 manages a network composed of the plurality of communication apparatuses 10-1 and 10-2. The management server 20 includes a management unit 22, which is management means, a reception unit 24, which is reception means, and an update unit 26, which is update means. The management unit 22 manages network information. The network information indicates a network structure composed of a plurality of nodes, network parameters (e.g., IP addresses) associated with the plurality of respective nodes in advance, and apparatus identification information (e.g., MAC addresses) that identifies the communication apparatuses corresponding to the plurality of respective nodes. Further, in the network information, a first node and a second node are adjacent to each other. The network structure is not necessarily composed of only the first node and the second node and may be composed of three or more nodes.

The reception unit 24 receives, from the communication apparatus 10-2 corresponding to the second node, a change notification indicating that the communication apparatus 10-1 corresponding to the first node has been changed. The update unit 26 updates information regarding the first node in the network information using the change notification.

According to the communication system 1 according to the exemplary embodiments of the present invention, it becomes possible to allocate the network parameter desired by the user to the communication apparatus corresponding to the node that constitutes the network structure constructed in advance in a simpler way. By using the management server 20, and the network management method and the program achieved by the management server 20 as well, the network parameter desired by the user can be allocated to the communication apparatus corresponding to the node that constitutes the network structure constructed in advance in a simpler way.

### First Exemplary Embodiment

Hereinafter, with reference to the drawings, a first exemplary embodiment will be described.

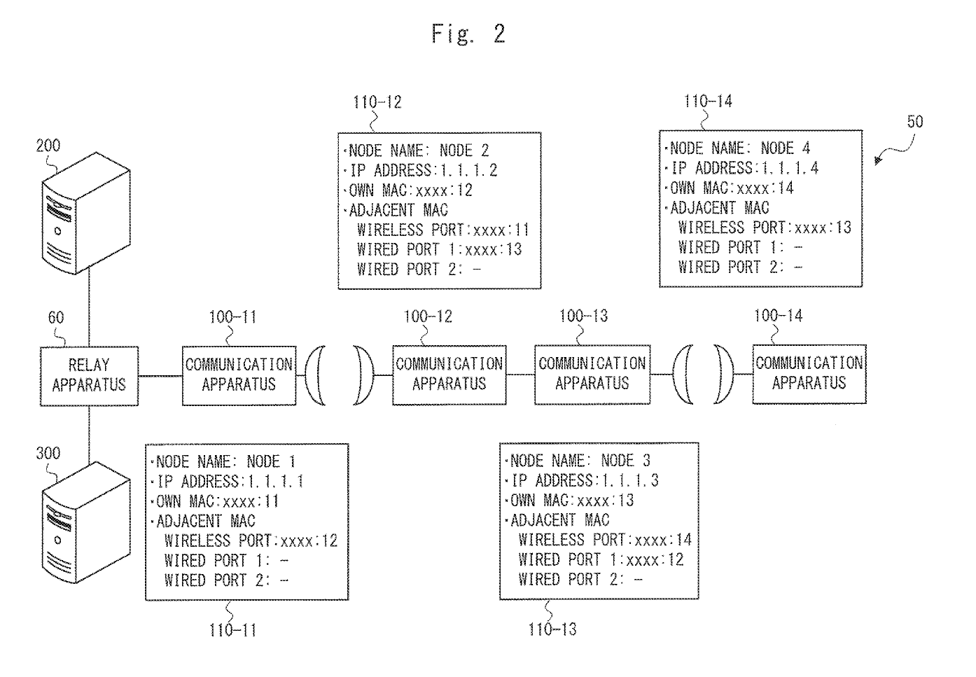

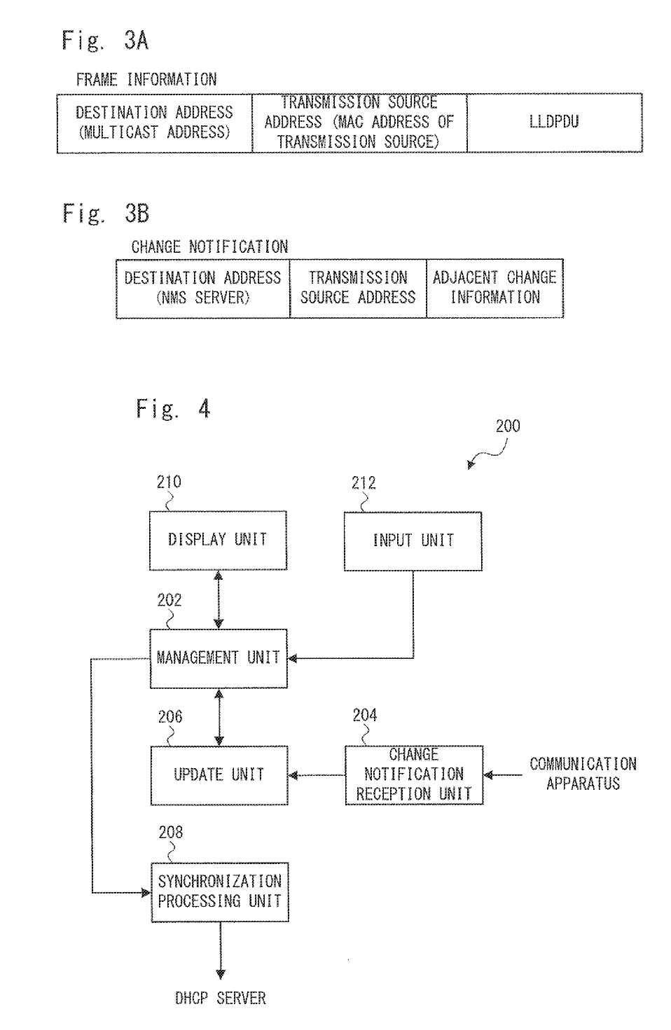

FIG. 2 is a diagram showing a communication system 50 according to the first exemplary embodiment. Further, FIGS. 3A and 3B are diagrams illustrating information transmitted in the communication system 50. The communication system 50 includes a plurality of communication apparatuses 100-11, 100-12, 100-13, and 100-14, a relay apparatus 60, an NMS server 200, and a DHCP server 300.

The communication apparatuses 100-11, 100-12, 100-13, and 100-14 each include a function as a network element (NE) in the network. The communication apparatuses 100-11, 100-12, 100-13, and 100-14 may include the same components. In the following description, it is assumed that the communication apparatuses 100-11, 100-12, 100-13, and 100-14 have the same components. Further, in the following description, the communication apparatuses 100-11, 100-12, 100-13, and 100-14 will be collectively called a communication apparatus 100. That is, the communication apparatuses 100-11, 100-12, 100-13, and 100-14 may be collectively called a communication apparatus 100 when it is not necessary to differentiate them. The other communication apparatuses including a function similar to that of the communication apparatus 100-11 and the like are called a communication apparatus 100. The number of communication apparatuses 100 may be any desired number.

The communication apparatus 100 includes one or more wireless ports and one or more wired ports and is connected to other communication apparatuses 100 via these connection ports. In the first exemplary embodiment shown below, the communication apparatus 100 includes one wireless port and two wired ports (a “wired port 1” and a “wired port 2”). However, the present invention is not limited to this example.

The communication apparatus 100-11 is connected to the relay apparatus 60, for example, in a wired manner. Further, the communication apparatus 100-11 is communicatively connected to the communication apparatus 100-12 via the wireless link. Further, the communication apparatus 100-12 is connected to the communication apparatus 100-13 in a wired manner. Further, the communication apparatus 100-13 is communicatively connected to the communication apparatus 100-14 via the wireless link.

That is, the communication apparatus 100-11 is connected to the communication apparatus 100-12 via the wireless port. Further, the communication apparatus 100-12 is connected to the communication apparatus 100-11 via the wireless port and is connected to the communication apparatus 100-13 via the wired port 1. Further, the communication apparatus 100-13 is connected to the communication apparatus 100-12 via the wired port 1 and is connected to the communication apparatus 100-14 via the wireless port. Further, the communication apparatus 100-14 is connected to the communication apparatus 100-13 via the wireless port. In this way, the communication apparatus 100 communicates with the adjacent communication apparatuses 100 (adjacent apparatuses) connected thereto in a wired or wireless manner.

Further, the communication apparatuses 100-11 to 100-14 respectively store management information 110-11 to 110-14 as shown in FIG. 2. The management information 110 is information to manage the communication network in the communication system 50 and includes information indicating configuration information of the communication apparatus, the connection relation of the communication apparatus in the communication network and the like. As shown in FIG. 2, for example, the management information includes the node name of the communication apparatus, the IP address of the communication apparatus, the MAC address of the communication apparatus (own MAC address), and the MAC address of the communication apparatus 100 which is adjacent to the communication apparatus (adjacent MAC address). The node name, the IP address, and the adjacent MAC address will be described later in detail. The node name of the communication apparatus may not be included in the management information 110.

As shown in FIG. 2, the MAC address of the communication apparatus 100-11 is “xxxx:11”. In a similar way, the MAC address of the communication apparatus 100-12 is “xxxx:12”. The MAC address of the communication apparatus 100-13 is “xxxx:13”. The MAC address of the communication apparatus 100-14 is “xxxx:14”.

FIG. 3A is a diagram illustrating frame information transmitted to the adjacent apparatus by each of the communication apparatuses 100. When each of the communication apparatuses 100 is communicatively connected to another communication apparatus 100 in a wired or wireless manner, each of the communication apparatuses 100 transmits the frame information to the communication apparatus 100 connected thereto (adjacent apparatus) in, for example, a multicast, at regular time intervals. The frame information may be, for example, a Link Layer Discovery Protocol (LLDP) frame. As illustrated in FIG. 3A, the frame information includes at least a destination address and a transmission source address. The destination address is a multicast address. Further, the transmission source address is a MAC address of the communication apparatus 100 that transmits the frame information. Further, when the frame information is the LLDP frame, the frame information may include LLDPDU (Data Unit). The communication apparatus 100 that has received the frame information from the adjacent apparatus determines via which connection port the frame information has been received. Accordingly, the communication apparatus 100 is able to determine the MAC address of the adjacent apparatus connected via each connection port. Further, the communication apparatus 100 updates the management information 110 using the frame information received from the adjacent apparatus.

The communication apparatus 100-12 receives, for example, the frame information including a MAC address “xxxx:11” from the communication apparatus 100-11 via the wireless port. In a similar way, the communication apparatus 100-12 receives the frame information including a MAC address “xxxx:13” from the communication apparatus 100-13 via the wired port 1. Accordingly, as shown in FIG. 2, the communication apparatus 100-12 stores the MAC address of the adjacent apparatus connected via the wireless port is “xxxx:11” in the management information 110-12. In a similar way, the communication apparatus 100-12 stores the MAC address of the adjacent apparatus connected via the wired port 1 is “xxxx:13” in the management information 110-12. Further, since the communication apparatus 100-12 does not receive the frame information via the wired port 2, the MAC address corresponding to the wired port 2 is stored as “-” in the management information 110-12. With regard to the other communication apparatuses 100, as shown in FIG. 2, the MAC address of the adjacent apparatus connected via each connection port is stored in the management information 110. In other words, each of the communication apparatuses 100 stores, in the management information 110, the connection ports in association with the MAC addresses of the adjacent apparatuses connected via the respective connection ports.

Further, the communication apparatus 100 includes a function such as a switch and a router. Accordingly, each of the communication apparatuses 100 is able to forward information (packet) received from the adjacent apparatus to another apparatus. The communication apparatus 100-12 may forward, for example, the information received from the communication apparatus 100-13 to the communication apparatus 100-11. Further, the communication apparatus 100-11 may forward the information received from the communication apparatus 100-12 to the NMS server 200 or the DHCP server 300 via the relay apparatus 60. Further, the communication apparatus 100-11 may forward the information received from the NMS server 200 or the DHCP server 300 via the relay apparatus 60 to the communication apparatus 100-12. In this way, each of the communication apparatuses 100 is able to communicate with the NMS server 200 or the DHCP server 300 via one or more other communication apparatuses 100. For example, while the communication apparatus 100-13 is not physically and directly connected to the NMS server 200 and the DHCP server 300, the communication apparatus 100-13 is able to communicate with the NMS server 200 and the DHCP server 300 via the communication apparatus 100-12 and the communication apparatus 100-11.

FIG. 3B is a diagram illustrating the change notification transmitted to the NMS server 200 by each of the communication apparatuses 100. Each of the communication apparatuses 100 generates the change notification when the management information 110 stored therein is updated. Specifically, each of the communication apparatuses 100 generates, when at least the adjacent apparatus is changed, the change notification and transmits the change notification that has been generated to the NMS server 200.

As illustrated in FIG. 3B, the change notification includes the destination address and the transmission source address. The destination address is an address of the NMS server 200 (e.g., an IP address). Further, the transmission source address is an address of the communication apparatus 100 that has generated the change notification (e.g., an IP address). Further, when the adjacent apparatus has been changed, the change notification includes adjacent change information. The adjacent change information will be described later. Each of the communication apparatuses 100 may generate the change notification when the state thereof has been changed.

“When the adjacent apparatus has been changed” includes, for example, a case in which the MAC address of the adjacent apparatus has been changed. Further, “when the MAC address of the adjacent apparatus has been changed” means a case in which the MAC address included in the frame information received from one connection port has been changed. The “change in the MAC address” includes, for example, “deletion” and “addition”. A “deletion” is performed when the frame information can no longer be received via a connection port in a state in which a specific MAC address has been associated with this connection port. Further, an “addition” is performed when the frame information has been received via a connection port in a state in which a specific MAC address has not been associated with this connection port.

The relay apparatus 60 forwards the information received from the communication apparatus 100-11 to the NMS server 200 or the DHCP server 300. Specifically, the relay apparatus 60 forwards, when the destination of the information that has been received indicates the NMS server 200, this information to the NMS server 200. Further, the relay apparatus 60 forwards, when the destination of the information that has been received indicates the DHCP server 300, this information to the DHCP server 300. Further, the relay apparatus 60 transmits the information received from the NMS server 200 or the DHCP server 300 to the communication apparatus 100-11.

The NMS server 200 includes a function as the management server that manages the network composed of the plurality of communication apparatuses 100. The details of this function will be described later. The DHCP server 300 serves as an allocation server that allocates the network parameter such as an IP address (a logical address) that is set to allow the communication apparatus 100 to perform communication to each of the communication apparatuses 100.

The NMS server 200 may manage the network shown in FIG. 2 in compliance with, for example, a Simple Network Management Protocol (SNMP). In this case, each of the communication apparatuses 100 may transmit the change notification to the NMS server 200 by Trap. Further, the NMS server 200 may transmit GetRequest to each of the communication apparatuses 100 and each of the communication apparatuses 100 may transmit the change notification to the NMS server 200 in response to the reception of the GetRequest. Further, the NMS server 200 may manage the network using Management Information Base (MIB) information. In this case, each of the communication apparatuses 100 may store the MIB information indicating the network structure. In other words, the management information stored in each of the communication apparatuses 100 may be the MIB information. Further, the change notification may have a format that is compliant with the MIB or may be MIB information (management information).

FIG. 4 is a functional block diagram of the NMS server 200 according to the first exemplary embodiment. The NMS server 200 includes a management unit 202, a change notification reception unit 204, an update unit 206, a synchronization processing unit 208, a display unit 210, and an input unit 212. The components shown in FIG. 4 will be described later.

The NMS server 200 may include, besides the components shown in FIG. 4, a function as a computer. That is, the NMS server 200 may include a processing apparatus such as a CPU, a storage device such as a memory, a communication equipment such as the communication apparatus 100 and the DHCP server 300 that communicates with another apparatus, and an input/output apparatus, which is a user interface. Further, the input/output apparatus may include an input apparatus such as a keyboard and a mouse and an output apparatus such as a monitor. Further, the input/output apparatus may be a Graphical User Interface (GUI). That is, the input/output apparatus may be composed of display means and input means that are integrated with each other and may be a touch panel, a touch screen or the like.

Further, each of the components shown in FIG. 4 may be achieved by causing a processing apparatus such as a CPU to execute a computer program stored in a storage device such as a memory. That is, this program causes a computer to achieve the function of each of the aforementioned components. Further, each of the components may not be achieved by software using the program and may instead be achieved by a combination of hardware, firmware, and software. Further, each of the components shown in FIG. 4 may be implemented, for example, using an integrated circuit such as a field-programmable gate array (FPGA) or a microcomputer that can be programmed by a user. In this case, a program composed of each of the aforementioned components may be achieved using this integrated circuit. The same is applicable to the other apparatuses such as the communication apparatus 100 and the DHCP server 300.

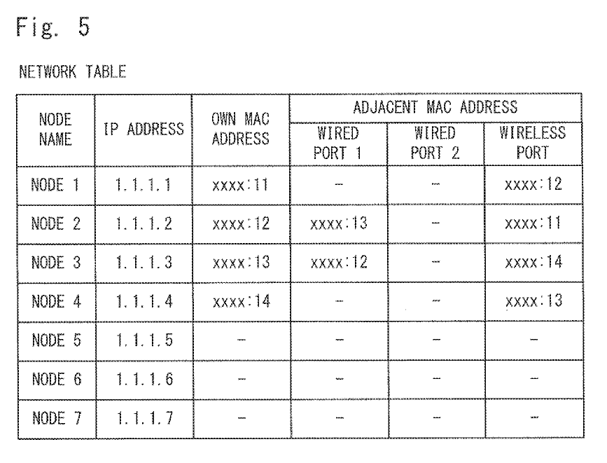

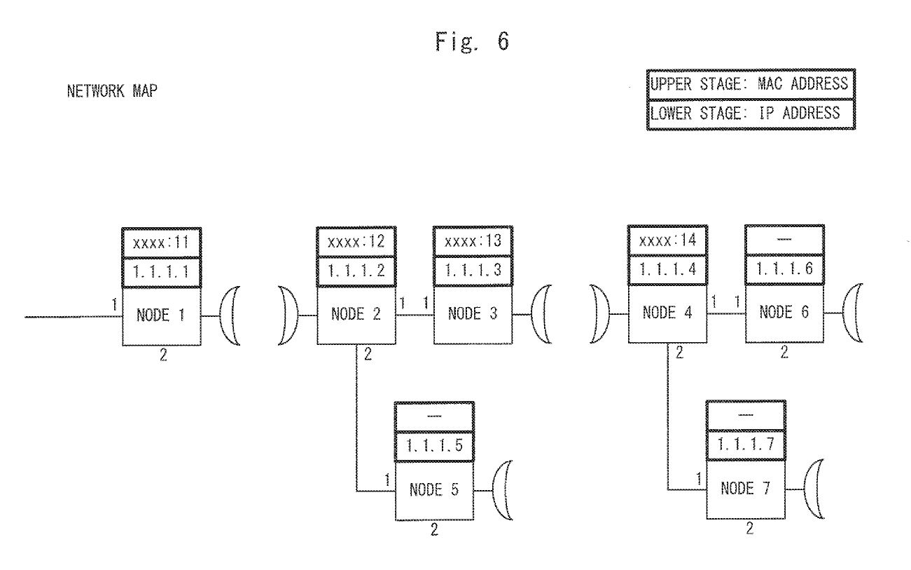

The management unit 202 stores and manages the network information. The network information is, as will be described later with reference to FIGS. 5 and 6, information indicating at least the network structure constructed by the user in advance. The network information includes a network table indicating the network structure in the form of a table and a network map indicating the network structure in the form of a map. Further, the network structure is composed of a plurality of virtual nodes and these nodes are connected to other nodes. The network structure is, for example, a network topology or a tree structure of the network. The communication apparatus 100 is installed to correspond to these logical nodes, whereby the physical communication system (communication network) is constructed.

FIG. 5 is a diagram illustrating the network table according to the first exemplary embodiment. Further, FIG. 6 is a diagram illustrating the network map according to the first exemplary embodiment. As illustrated in FIGS. 5 and 6, the network structure according to the first exemplary embodiment is composed of nodes 1 to 7. The management unit 202 of the NMS server 200 stores a virtual network structure composed of the nodes 1 to 7 in advance using the network information illustrated in FIGS. 5 and 6. That is, the management unit 202 is able to determine which node is connected to which connection port of each node using the network information. The network structure is not limited to the one illustrated in FIGS. 5 and 6. The number of nodes that constitute the network structure and the connection states of the nodes are determined by the user as appropriate.

As illustrated in FIG. 6, the wireless port of the node 1 and the wireless port of the node 2 are connected to each other. The NMS server 200 is connected to the wired port 1 of the node 1 via the relay apparatus 60. Further, no node is connected to the wired port 2 of the node 1. Further, the wired port 1 of the node 2 and the wired port 1 of the node 3 are connected to each other. Further, the wireless port of the node 3 and the wireless port of the node 4 are connected to each other. No node is connected to the wired port 2 of the node 3. Further, the wired port 1 of the node 4 and the wired port 1 of the node 6 are connected to each other. No node is connected to the wired port 2 and the wireless port of the node 6. In this way, the nodes 1 to 6 are connected in series.

Further, the wired port 2 of the node 2 and the wired port 1 of the node 5 are connected to each other. No node is connected to the wired port 2 and the wireless port of the node 5. Further, the wired port 2 of the node 4 and the wired port 1 of the node 7 are connected to each other. No node is connected to the wired port 2 and the wireless port of the node 7. In this way, nodes are connected to the plurality of respective wired ports of one node, whereby a branched structure is constructed.

Further, as illustrated in FIGS. 5 and 6, IP addresses “1.1.1.1” to “1.1.1.7”, which are logical addresses, are associated with the respective nodes 1 to 7 in advance. In this way, in the first exemplary embodiment, the management unit 202 of the NMS server 200 stores the network structure composed of the plurality of nodes in advance. Further, the management unit 202 of the NMS server 200 stores the respective nodes that constitute the network structure associated with the IP addresses in advance.

In the example shown in FIG. 2, the communication apparatus 100-11 is installed in the position corresponding to the node 1. Further, the communication apparatus 100-12 is installed in the position corresponding to the node 2. Further, the communication apparatus 100-13 is installed in the position corresponding to the node 3. Further, the communication apparatus 100-14 is installed in the position corresponding to the node 4. That is, the communication apparatuses 100 corresponding to the nodes 1 to 4 are the communication apparatuses 100-11 to 100-14, respectively. On the other hand, the communication apparatuses 100 are not installed in the positions corresponding to the nodes 5 to 7.

Further, the network information indicates which communication apparatuses 100 are actually installed in the positions corresponding to the nodes 1 to 7. In the network information, the respective nodes and the communication apparatuses 100 are associated with each other using the MAC addresses. As illustrated in FIGS. 5 and 6, the MAC address “xxxx:11” of the communication apparatus 100-11 (the “own MAC address” in FIG. 5) is associated, for example, with the node 1. In a similar way, the MAC address “xxxx:12” of the communication apparatus 100-12 is associated, for example, with the node 2. On the other hand, since there are no communication apparatuses 100 corresponding to the nodes 5 to 7, the field of the “own MAC address” is blank. In this way, the management unit 202 of the NMS server 200 stores the MAC address, which is identification information that identifies the communication apparatuses 100 corresponding to the respective nodes. That is, the NMS server 200 is able to determine in which node which communication apparatus 100 including which MAC address is installed.

As stated above, the IP addresses are associated with the respective nodes in advance. Accordingly, in the network information, the respective MAC addresses and the respective IP addresses are associated with each other. The IP addresses are allocated to the communication apparatuses 100 using the correspondence between the MAC addresses and the IP addresses. The actual processing of allocating the IP addresses is performed by the DHCP server 300. The details of this processing will be described later.

Further, the network information indicates the MAC address corresponding to the adjacent node adjacent to each node. In other words, the network information indicates the MAC address of the apparatus adjacent to the communication apparatus 100 corresponding to each node. Specifically, in the network table shown in FIG. 5, the “adjacent MAC address” indicates the MAC address of the communication apparatus 100 corresponding to the node connected to each connection port of each node.

The network table shows, for example, that the MAC address “xxxx:12” of the communication apparatus 100-12 corresponding to the node 2 is associated with the wireless port of the node 1. In a similar way, the network table shows that the MAC address “xxxx:11” of the communication apparatus 100-11 corresponding to the node 1 is associated with the wireless port of the node 2. Accordingly, the management unit 202 is able to determine that the communication apparatus 100 of the MAC address “xxxx:11” and the communication apparatus 100 of the MAC address “xxxx:12” are adjacent to each other. The network table also shows that MAC address “xxxx:13” of the communication apparatus 100-13 corresponding to the node 3 is associated with the wired port 1 of the node 2. In a similar way, the MAC address “xxxx:12” of the communication apparatus 100-12 corresponding to the node 2 is associated with the wired port 1 of the node 3. Accordingly, the management unit 202 is able to determine that the communication apparatus 100 of the MAC address “xxxx:12” and the communication apparatus 100 of the MAC address “xxxx:13” are adjacent to each other.

In this way, the management unit 202 is able to determine which communication apparatus 100 of which MAC address is adjacent to which communication apparatus 100 of which MAC address. The management unit 202 is able to determine which communication apparatus 100 of which MAC address is adjacent to which communication apparatus 100 of which MAC address from the network map illustrated in FIG. 6 as well.

The change notification reception unit 204 (FIG. 4) receives the change notification illustrated in FIG. 3B from each of the communication apparatuses 100. The way in which the change notification is transmitted from each of the communication apparatuses 100 will be described later. Further, the change notification reception unit 204 outputs the change notification that has been received to the update unit 206.

The update unit 206 updates the network information stored in the management unit 202 using the change notification. Specifically, when the “adjacent change information” is included in the change notification, the update unit 206 updates information regarding the communication apparatus 100 adjacent to the communication apparatus 100 that has generated the change notification in the network information using the adjacent change information. In other words, the update unit 206 updates information regarding the adjacent node of the node corresponding to the communication apparatus 100 that has generated the change notification using the adjacent change information. In the first exemplary embodiment, the information to be updated is the MAC address. The detailed processing in the update unit 206 will be described later.

The synchronization processing unit 208 includes a function as synchronization processing means. The synchronization processing unit 208 performs processing for synchronizing the network information stored in the management unit 202 with the allocation information stored in the DHCP server 300 (the details thereof will be described later with reference to FIG. 8). Specifically, when the network information has been updated by the update unit 206, the synchronization processing unit 208 transmits a notification indicating that the network information has been updated (network information update notification) to the DHCP server 300. The network information update notification includes at least information indicating the correspondence between the IP address and the MAC address after the update.

The display unit 210 includes a function as display means. The display unit 210 performs processing for displaying the network information stored in the management unit 202. The display unit 210 may display, for example, the network information on an output apparatus (an input/output apparatus) embedded in the NMS server 200. Alternatively, the display unit 210 may display the network information on an output apparatus (an input/output apparatus) that is provided separately from the NMS server 200 and is communicatively connected to the NMS server 200.

The display unit 210 displays, for example, at least one of the network table illustrated in FIG. 5 and the network map illustrated in FIG. 6. The display unit 210 may display the network information every time the network information is updated. In this case, the display unit 210 may accept information indicating that the network information has been updated from the management unit 202.

The input unit 212 accepts the user's operation performed on an input apparatus (input/output apparatus) and outputs information indicating this operation to the management unit 202. The management unit 202 performs appropriate processing in accordance with the information from the input unit 212. The input unit 212 may accept, for example, an instruction for causing the network information to be displayed performed by the user. In this case, the management unit 202 may output the instruction for causing the network information to be displayed to the display unit 210.

Further, the display unit 210 may display, when the network information is displayed in accordance with the update of the network information, a screen asking the user whether to allow the update of the network information. In this case, the input unit 212 may accept the operation indicating whether to allow or reject the update. When, for example, one communication apparatus 100 (MAC address “xxxx:99”) is installed in the position corresponding to the node 7 but the user does not desire that the communication apparatus 100 of the MAC address “xxxx:99” be installed, the user is able to instruct the NMS server 200 to reject the installation of the communication apparatus 100 of the MAC address “xxxx:99”. Further, the display unit 210 may display a message that asks the user whether to allow the allocation of the IP address to the MAC address.

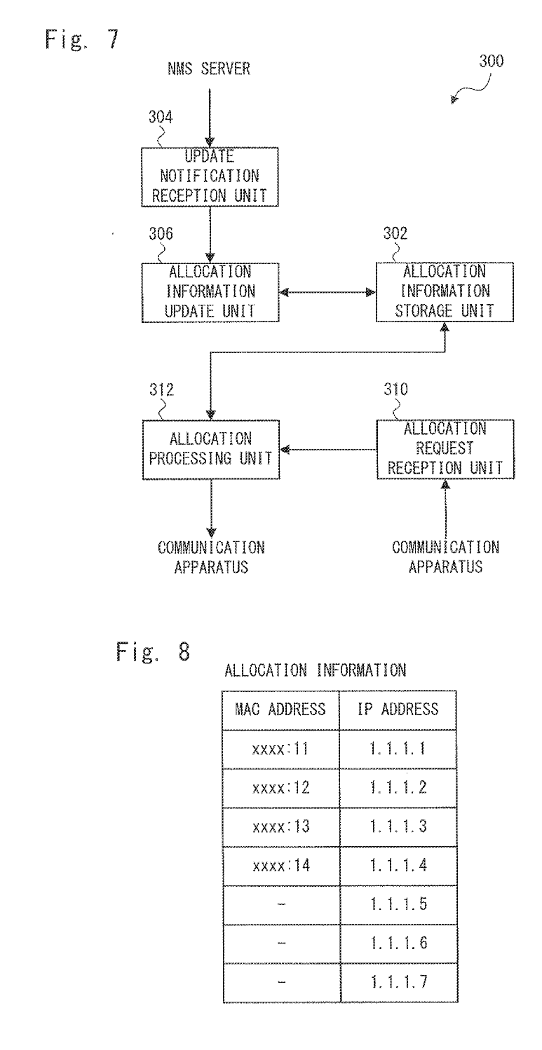

FIG. 7 is a functional block diagram of the DHCP server 300 according to the first exemplary embodiment. The DHCP server 300 includes an allocation information storage unit 302, an update notification reception unit 304, an allocation information update unit 306, an allocation request reception unit 310, and an allocation processing unit 312. The DHCP server 300 may include, similar to the NMS server 200, besides the components shown in FIG. 7, a function as a computer. Further, similar to the NMS server 200, each of the components shown in FIG. 7 may be achieved by causing a processing apparatus such as a CPU to execute a computer program stored in a storage device such as a memory.

The allocation information storage unit 302 stores the allocation information illustrated in FIG. 8.

FIG. 8 is a diagram illustrating the allocation information stored in the allocation information storage unit 302. The allocation information indicates a correspondence between the IP address and the MAC address. As indicated in the allocation information, IP addresses are allocated to the communication apparatuses 100 corresponding to the respective MAC addresses. For example, the IP address “1.1.1.1” is allocated to the communication apparatus 100-11 of the MAC address “xxxx:11”.

The update notification reception unit 304 receives the network information update notification from the NMS server 200 and outputs the network information update notification that has been received to the allocation information update unit 306. The allocation information update unit 306 updates the allocation information in accordance with the network information update notification. Accordingly, the network information is synchronized with the allocation information. The details of this processing will be described later.

The allocation request reception unit 310 receives the DHCP request for requesting the IP address to be allocated to the communication apparatus 100 from the communication apparatus 100. The allocation processing unit 312 performs processing for allocating the IP address to the communication apparatus 100 that has transmitted the DHCP request. The details of this processing will be described later.

### (Operations)

Hereinafter, specific operations in the communication system 50 will be described. First, a case in which one communication apparatus 100 is replaced by another communication apparatus 100 will be described. That is, a case in which one communication apparatus 100 is removed and another communication apparatus 100 is installed in the position where the former communication apparatus 100 has been removed will be described.

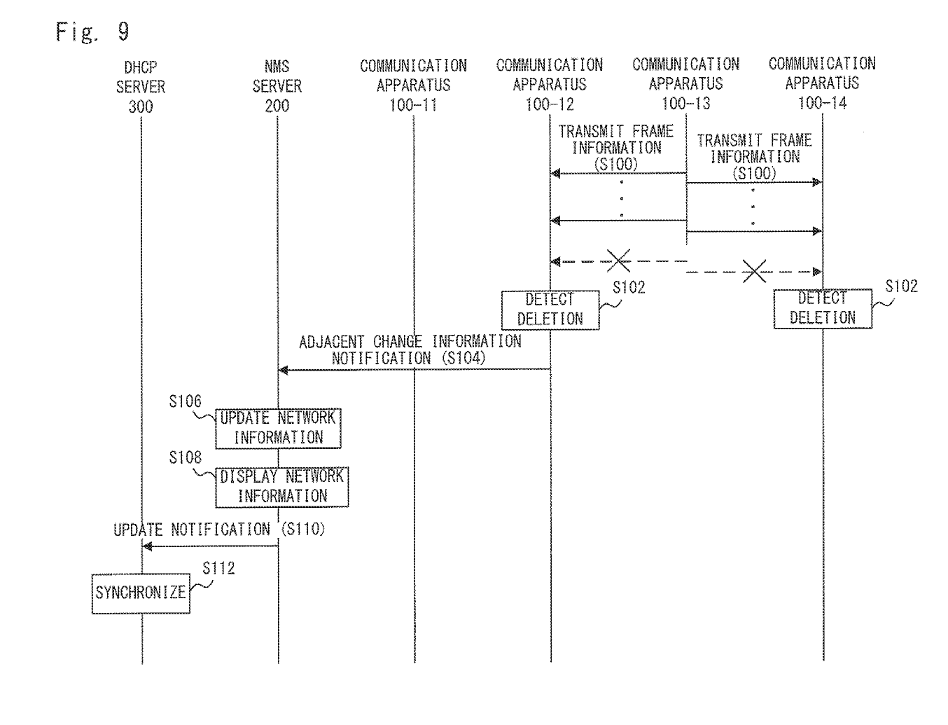

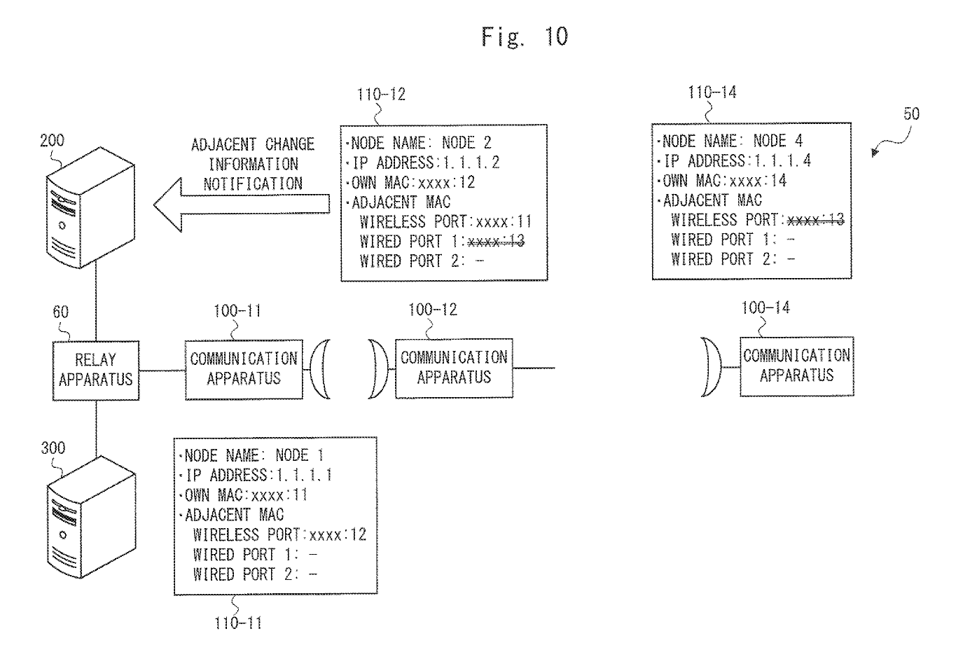

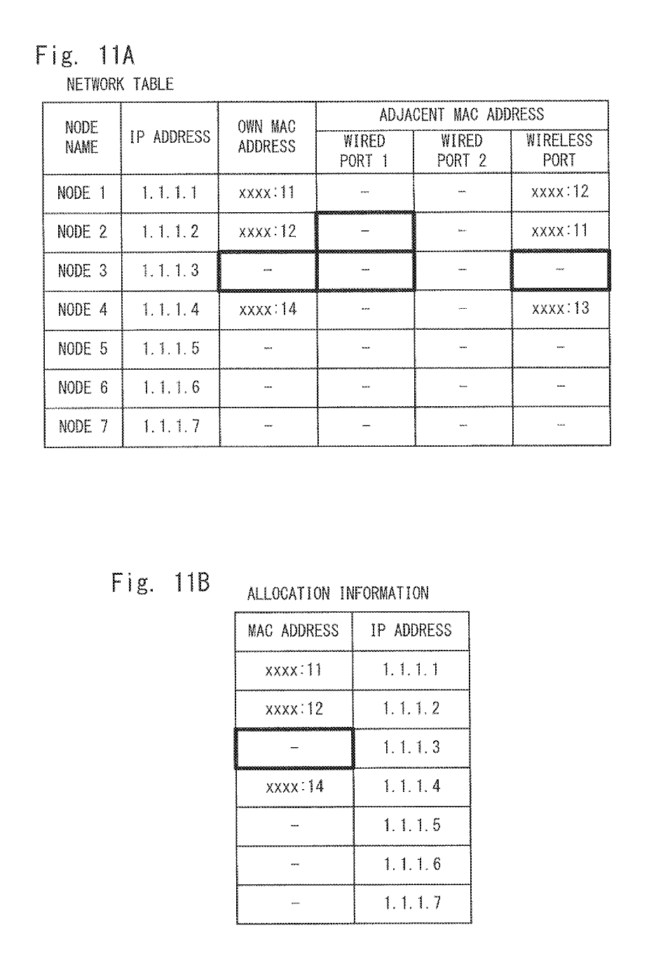

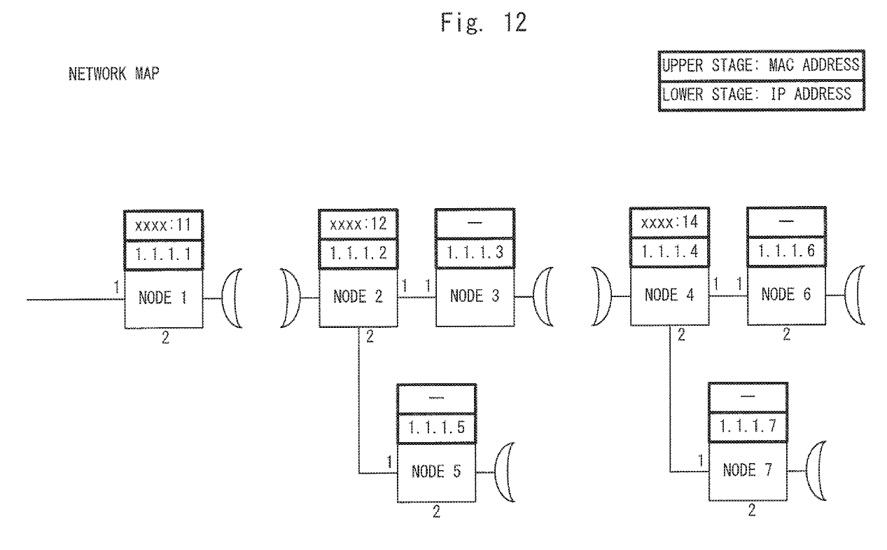

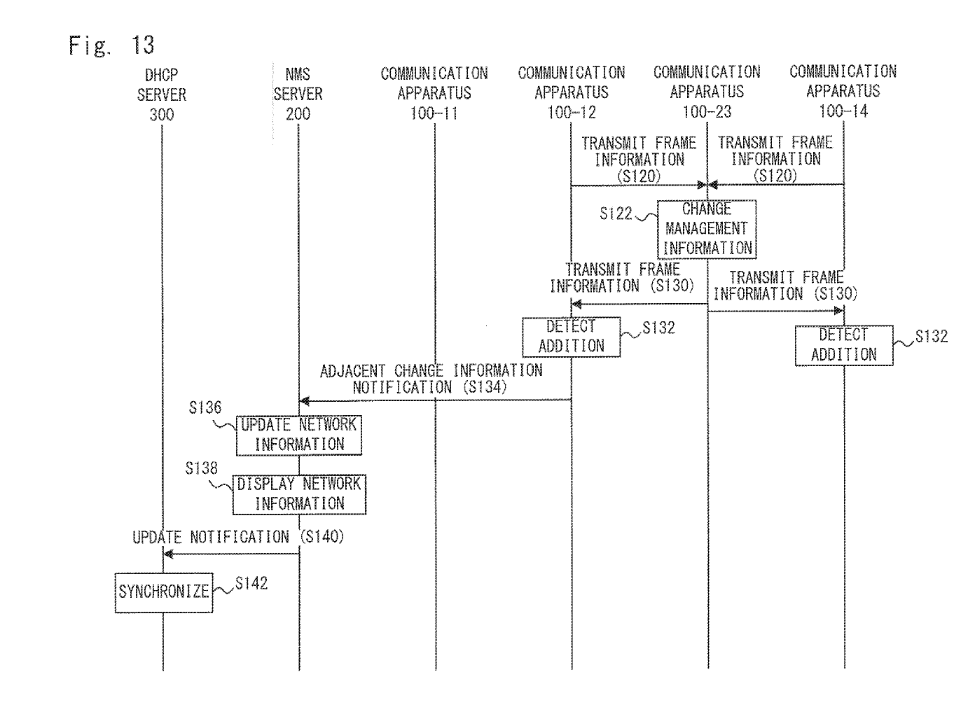

FIG. 9 is a sequence diagram showing a process flow in the communication system 50 when one communication apparatus 100 is deleted according to the first exemplary embodiment. Further, FIG. 10 is a diagram schematically showing a state in which one communication apparatus 100 is deleted. FIGS. 9 and 10 illustrate a case in which the communication apparatus 100-13 is deleted. Further, FIGS. 11A, 11B, and 12 are diagrams illustrating the network information and the allocation information in the examples of FIGS. 9 and 10. FIG. 11A illustrates the network table, FIG. 11B illustrates the allocation information, and FIG. 12 illustrates the network map.

Before the communication apparatus 100-13 is deleted, the communication apparatus 100-13 transmits the frame information including the MAC address of the communication apparatus 100-13 to the communication apparatus 100-12 and the communication apparatus 100-14, which are adjacent to the communication apparatus 100-13, at regular time intervals (S100). Therefore, the communication apparatus 100-12 and the communication apparatus 100-14 are each able to determine that the communication apparatus 100 of the MAC address “xxxx:13” is adjacent to each of the communication apparatus 100-12 and the communication apparatus 100-14 by the management information 110-12 and the management information 110-14, respectively.

After that, the communication apparatus 100-13 is removed. Accordingly, the communication apparatus 100-12 does no longer receive the frame information from the communication apparatus 100-13. When the communication apparatus 100-12 does not receive the frame information from the communication apparatus 100-13 within a predetermined period of time, the communication apparatus 100-12 detects that the communication apparatus 100-13, which is adjacent to the communication apparatus 100-12, has been deleted (S102). Specifically, when the communication apparatus 100-12 does not receive the frame information via the wired port 1 within a predetermined period of time, the communication apparatus 100-12 detects that the communication apparatus 100 connected to the wired port 1 has been deleted. In this case, the communication apparatus 100-12 deletes, as shown in FIG. 10, the MAC address “xxxx:13” corresponding to the wired port 1 in the management information 110-12 stored in the communication apparatus 100-12. That is, the communication apparatus 100-12 changes the management information 110-12.

The processing of S102 is performed also in the communication apparatus 100-14. That is, since the communication apparatus 100-14 does not receive the frame information from the communication apparatus 100-13, the communication apparatus 100-14 detects that the communication apparatus 100-13, which is adjacent to the communication apparatus 100-14, has been deleted. Then, as shown in FIG. 10, the communication apparatus 100-14 deletes the MAC address “xxxx:13” corresponding to the wireless port in the management information 110-14 stored in the communication apparatus 100-14. That is, the communication apparatus 100-14 changes the management information 110-14.

The communication apparatus 100-12 notifies the NMS server 200 of the adjacent change information indicating that the adjacent apparatus has been changed (S104). Specifically, the communication apparatus 100-12 generates the adjacent change information indicating that the communication apparatus 100-13 has been deleted. More specifically, the adjacent change information generated in this case indicates that the communication apparatus 100 connected to the wired port 1 has been deleted. The adjacent change information is indicated, for example, as “wired port 1:deleted”.

Further, the communication apparatus 100-12 transmits the change notification including the adjacent change information that has been generated to the communication apparatus 100-11, which is adjacent to the communication apparatus 100-12. Since the destination of the change notification indicates the NMS server 200, the communication apparatus 100-11 forwards the change notification to the network on the side of the NMS server 200. In this case, the communication apparatus 100-11 forwards the change notification to the relay apparatus 60. The relay apparatus 60 forwards the change notification to the NMS server 200. In this way, the adjacent change information generated by the communication apparatus 100-12 is sent to the NMS server 200.

When the NMS server 200 receives the change notification, the NMS server 200 updates the network information (S106). Specifically, the update unit 206 of the NMS server 200 determines, from the transmission source address included in the change notification (e.g., the IP address “1.1.1.2”) and the network information, that the adjacent change information has been generated by the communication apparatus 100-12 (the communication apparatus of the MAC address “xxxx:12”). Then the update unit 206 determines, from the adjacent change information, that the communication apparatus 100 connected to the wired port 1 has been deleted.

The update unit 206 determines, from the network information, that the node corresponding to the communication apparatus 100 of the MAC address “xxxx:12” is the “node 2”. Accordingly, as shown in FIG. 11A, the update unit 206 deletes the MAC address “xxxx:13” that has been associated with the “wired port 1” of the “node 2” in the network table.

Further, the update unit 206 determines, from the network information, that the node that has been associated with the MAC address “xxxx:13” is the “node 3”. Accordingly, as shown in FIG. 11A, the update unit 206 deletes all the addresses that have been associated with the “node 3” in the network table. That is, the update unit 206 deletes the own MAC address “xxxx:13” and the adjacent MAC addresses “xxxx:12” and the “xxxx:14” that have been associated with the “node 3” in the network table. Further, as shown in FIG. 12, the update unit 206 deletes the MAC address “xxxx:13” that has been associated with the node 3 in the network map.

Since the communication apparatus 100-13 has been removed, the communication apparatus 100-14 cannot communicate with the NMS server 200. That is, the NMS server 200 cannot receive the change notification from the communication apparatus 100-14. Accordingly, the NMS server 200 does not update the information regarding the node 4 corresponding to the communication apparatus 100-14 at this point in time.

When the network information is updated, the NMS server 200 causes the network information that has been updated to be displayed (S108). Specifically, when the display unit 210 of the NMS server 200 accepts the information indicating that the network information has been updated from the management unit 202, the display unit 210 displays at least one of the network table illustrated in FIG. 11A and the network map illustrated in FIG. 12. Accordingly, the user (the administrator) of the NMS server 200 is able to confirm that the communication apparatus 100 corresponding to the node 3 has been deleted.

Further, the display unit 210 may display, besides the network information, a message indicating that the communication apparatus 100-13 of the MAC address “xxxx:13” corresponding to the node 3 has been deleted. Accordingly, the user (the administrator) is able to check which communication apparatus 100 has been deleted and which communication apparatus 100 corresponding to which node has been deleted more accurately. Further, in this case, the display unit 210 may display a screen asking the user whether to allow the deletion of the communication apparatus 100 corresponding to the node 3. In this case, the input unit 212 may accept the operation indicating whether to allow or reject the deletion of the communication apparatus 100-13 of the MAC address “xxxx:13” corresponding to the node 3.

Next, the NMS server 200 transmits the network information update notification to the DHCP server 300 (S110). Accordingly, the DHCP server 300 synchronizes the allocation information with the network information (S112). Specifically, the synchronization processing unit 208 of the NMS server 200 transmits the network information update notification indicating that the MAC address corresponding to the IP address “1.1.1.3” has been deleted to the DHCP server 300. Accordingly, as shown in FIG. 11B, the allocation information update unit 306 of the DHCP server 300 deletes the MAC address “xxxx:13” that has been associated with the IP address “1.1.1.3” in the allocation information. Accordingly, the allocation information is synchronized with the network information.

In this way, in this exemplary embodiment, when one communication apparatus 100 is removed, the NMS server 200 is able to update the network information without requiring any user's operation. Further, the NMS server 200 synchronizes the network information with the allocation information stored in the DHCP server 300, whereby it is possible to update the allocation information.

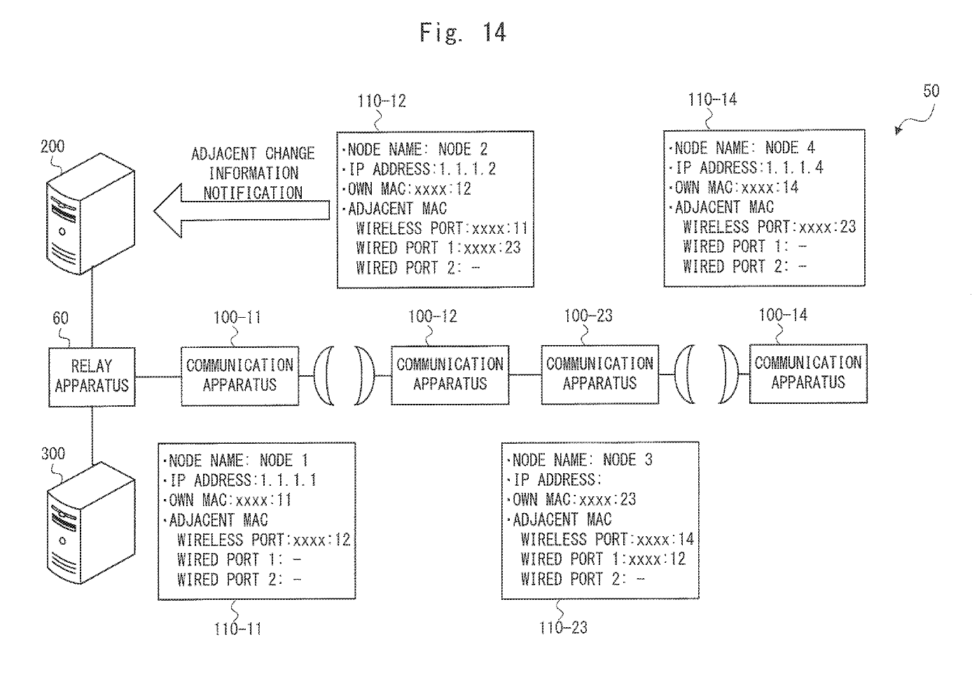

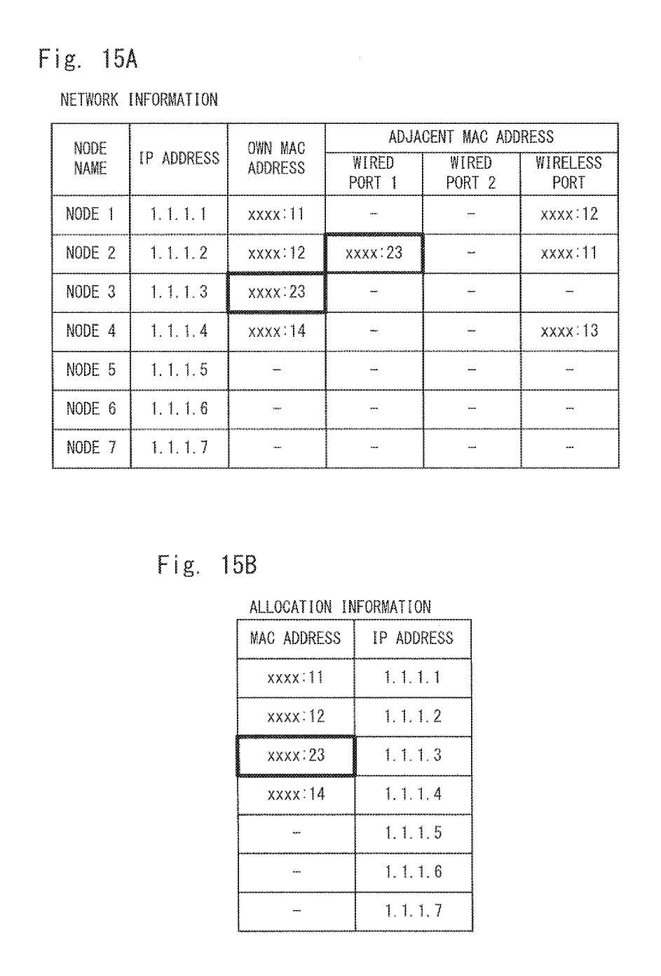

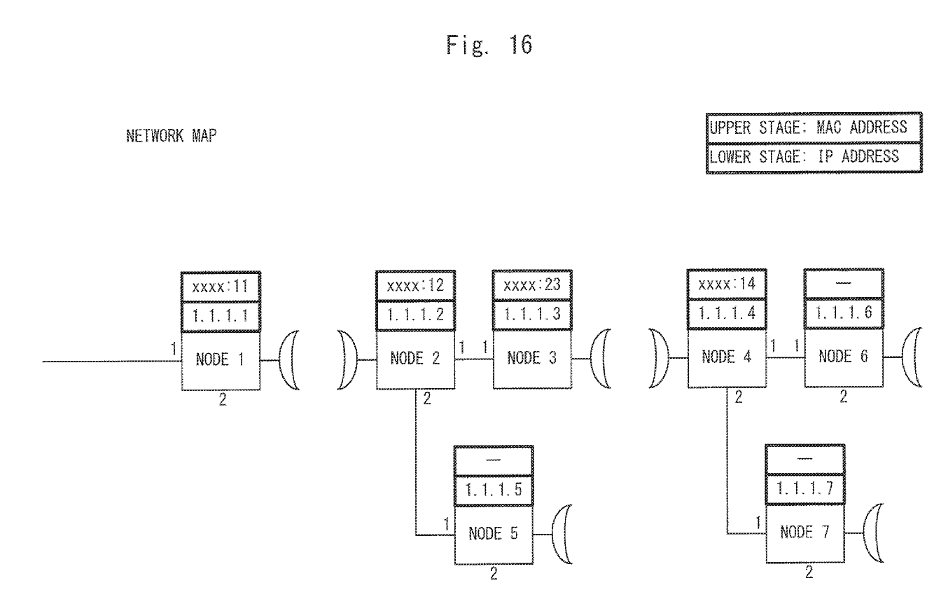

FIG. 13 is a sequence diagram showing a process flow in the communication system 50 when another communication apparatus 100 is installed in the position of the communication apparatus 100 that has been deleted in FIG. 9. FIG. 14 is a diagram schematically showing a state in which another communication apparatus 100 is installed in the position of the communication apparatus 100 that has been deleted. FIGS. 13 and 14 illustrate a case in which a communication apparatus 100-23 is installed in the position where the communication apparatus 100-13 has originally been installed. Further, FIGS. 15A, 15B, and 16 are diagrams illustrating the network information and the allocation information in the examples in FIGS. 13 and 14. FIG. 15A illustrates the network table, FIG. 15B illustrates the allocation information, and FIG. 16 illustrates the network map.

When the communication apparatus 100-13 is replaced by the communication apparatus 100-23, the communication apparatus 100-12 and the communication apparatus 100-14 transmit the frame information to the communication apparatus 100-23, which is adjacent to the communication apparatus 100-12 and the communication apparatus 100-14, at regular time intervals (S120). Specifically, when the communication apparatus 100-23 is installed, the communication apparatus 100-12 transmits the frame information including the MAC address “xxxx:12” of the communication apparatus 100-12 to the communication apparatus 100-23 at regular time intervals. In a similar way, the communication apparatus 100-14 transmits the frame information including the MAC address “xxxx:14” of the communication apparatus 100-14 to the communication apparatus 100-23 at regular time intervals.

Accordingly, the communication apparatus 100-23 changes, as shown in FIG. 14, the management information 110-23 stored in the communication apparatus 100-23 (S122). Specifically, the communication apparatus 100-23 associates, as shown in FIG. 14, the MAC address “xxxx:14” with the wireless port in the management information 110-23 stored in the communication apparatus 100-23. In a similar way, the communication apparatus 100-23 associates the MAC address “xxxx:12” with the wired port 1. In this case, since the IP address is not allocated to the communication apparatus 100-23, the communication apparatus 100-23 cannot communicate with the NMS server 200. Accordingly, the communication apparatus 100-23 does not transmit the change notification.

Further, when the communication apparatus 100-23 is installed, the communication apparatus 100-23 transmits the frame information including the MAC address “xxxx:23” of the communication apparatus 100-23 to the communication apparatus 100-12 and the communication apparatus 100-14, which are adjacent to the communication apparatus 100-23, at regular time intervals (S130). When the communication apparatus 100-12 receives the frame information from the communication apparatus 100-23, the communication apparatus 100-12 detects that the communication apparatus 100-23 has been added as the adjacent apparatus (S132).

Specifically, when the communication apparatus 100-12 receives the frame information via the wired port 1 in a state in which the adjacent apparatus is not connected to the communication apparatus 100-12 via the wired port 1, the communication apparatus 100-12 detects that the communication apparatus 100 has been added to the wired port 1. In other words, when the communication apparatus 100-12 receives the frame information via the wired port 1 in a state in which the adjacent MAC address is not associated with the wired port 1 in the management information 110-12, the communication apparatus 100-12 detects that the communication apparatus 100 has been added to the wired port 1. In this case, the communication apparatus 100-12 associates, as shown in FIG. 14, the MAC address “xxxx:23” with the wired port 1 in the management information 110-12 stored in the communication apparatus 100-12. That is, the communication apparatus 100-12 changes the management information 110-12.

The processing in S132 is performed in the communication apparatus 100-14 as well. That is, when the communication apparatus 100-14 receives the frame information via the wireless port in a state in which the adjacent apparatus is not connected to the communication apparatus 100-14 via the wireless port, the communication apparatus 100-14 detects that the communication apparatus 100 has been added to the wireless port. Then as shown in FIG. 14, the communication apparatus 100-14 associates the MAC address “xxxx:23” with the wireless port in the management information 110-14 stored in the communication apparatus 100-14. That is, the communication apparatus 100-14 changes the management information 110-14.

The communication apparatus 100-12 notifies the NMS server 200 of the adjacent change information indicating that the adjacent apparatus has been changed (S134). Specifically, the communication apparatus 100-12 generates the adjacent change information indicating that the communication apparatus 100-23 has been added. More specifically, the adjacent change information generated in this case indicates that the communication apparatus 100 of the MAC address “xxxx:23” has been connected to the wired port 1. The adjacent change information is indicated, for example, as “wired port 1:MAC address “xxxx:23” added”.

Similar to S104 in FIG. 9, the communication apparatus 100-12 transmits the change notification including the adjacent change information that has been generated to the communication apparatus 100-11, which is adjacent to the communication apparatus 100-12. The communication apparatus 100-11 forwards the change notification to the relay apparatus 60. The relay apparatus 60 forwards the change notification to the NMS server 200. Accordingly, the adjacent change information generated by the communication apparatus 100-12 is sent to the NMS server 200.

Upon receiving the change notification, the NMS server 200 updates the network information (S136). Specifically, the update unit 206 of the NMS server 200 determines that the adjacent change information has been generated by the communication apparatus 100-12 (the apparatus of the MAC address “xxxx:12”) from the transmission source address included in the change notification (e.g., the IP address “1.1.1.2”) and the network information. The update unit 206 determines, based on the adjacent change information, that the communication apparatus 100 of the MAC address “xxxx:23” has been connected to the wired port 1. The update unit 206 determines, based on the network information, that the node corresponding to the communication apparatus 100 of the MAC address “xxxx:12” is the “node 2”. Therefore, as shown in FIG. 15A, the update unit 206 associates the MAC address “xxxx:23” with the “wired port 1” of the “node 2” in the network table.

Further, the update unit 206 determines that the node connected to the “wired port 1” of the “node 2” is the “node 3” using the network information. Therefore, as shown in FIG. 15A, the update unit 206 associates the MAC address “xxxx:23” with the “node 3” in the network table. Further, as shown in FIG. 16, the update unit 206 associates the MAC address “xxxx:23” with the node 3 in the network map. In this way, the update unit 206 is able to accurately associate the MAC address of the communication apparatus 100-23 after the replacement with the node 3 corresponding to the communication apparatus 100-13 before the replacement. As stated above, the IP address “1.1.1.3” is associated with the node 3. Accordingly, the update unit 206 is able to associate the IP address “1.1.1.3” associated with the communication apparatus 100-13 before the replacement with the communication apparatus 100-23 after the replacement. In this way, when the communication apparatus 100 is replaced by another communication apparatus 100, the NMS server 200 detects that the communication apparatus 100 has been replaced by another communication apparatus 100 by receiving the change notification. Then the NMS server 200 associates the IP address associated with the communication apparatus 100 before the replacement (in the aforementioned example, the communication apparatus 100-13) with the communication apparatus 100 after the replacement (in the aforementioned example, the communication apparatus 100-23). That is, the NMS server 200 includes detection means for detecting that the communication apparatus 100 that constitutes the network has been replaced and association means for associating the IP address that has been associated with the communication apparatus 100 before the replacement with the communication apparatus 100 after the replacement.

When the network information is updated, the NMS server 200 causes the network information that has been updated to be displayed (S138). Specifically, when the display unit 210 of the NMS server 200 accepts the information indicating that the network information has been updated from the management unit 202, the display unit 210 displays at least one of the network table illustrated in FIG. 15A and the network map illustrated in FIG. 16. Accordingly, the user (the administrator) of the NMS server 200 is able to confirm that the communication apparatus 100 corresponding to the node 3 has been added.

Further, the display unit 210 may display, besides the network information, a message indicating that the communication apparatus 100-23 of the MAC address “xxxx:23” corresponding to the node 3 has been added. The user (the administrator) is therefore able to check which communication apparatus 100 has been added and which communication apparatus 100 corresponding to which node has been added more accurately. Further, in this case, the display unit 210 may display a screen that asks the user whether to allow the addition of the communication apparatus 100-23 of the MAC address “xxxx:23” corresponding to the node 3. In this case, the input unit 212 may accept the operation indicating whether to allow or reject the addition of the communication apparatus 100-23. The same is applicable to other display processes that will be described later.

Next, the NMS server 200 transmits the network information update notification to the DHCP server 300 (S140). Accordingly, the DHCP server 300 synchronizes the allocation information with the network information (S142). Specifically, the synchronization processing unit 208 of the NMS server 200 transmits the network information update notification indicating that the MAC address “xxxx:23” has been associated with the IP address “1.1.1.3” to the DHCP server 300. Accordingly, as shown in FIG. 15B, the allocation information update unit 306 of the DHCP server 300 associates the MAC address “xxxx:23” with the IP address “1.1.1.3” in the allocation information. Accordingly, the allocation information is synchronized with the network information.

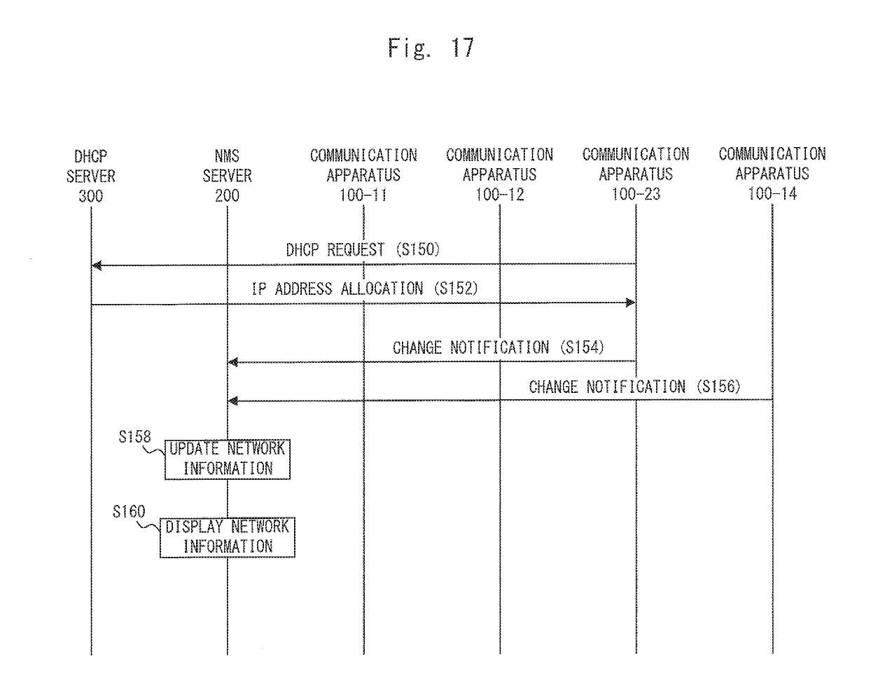

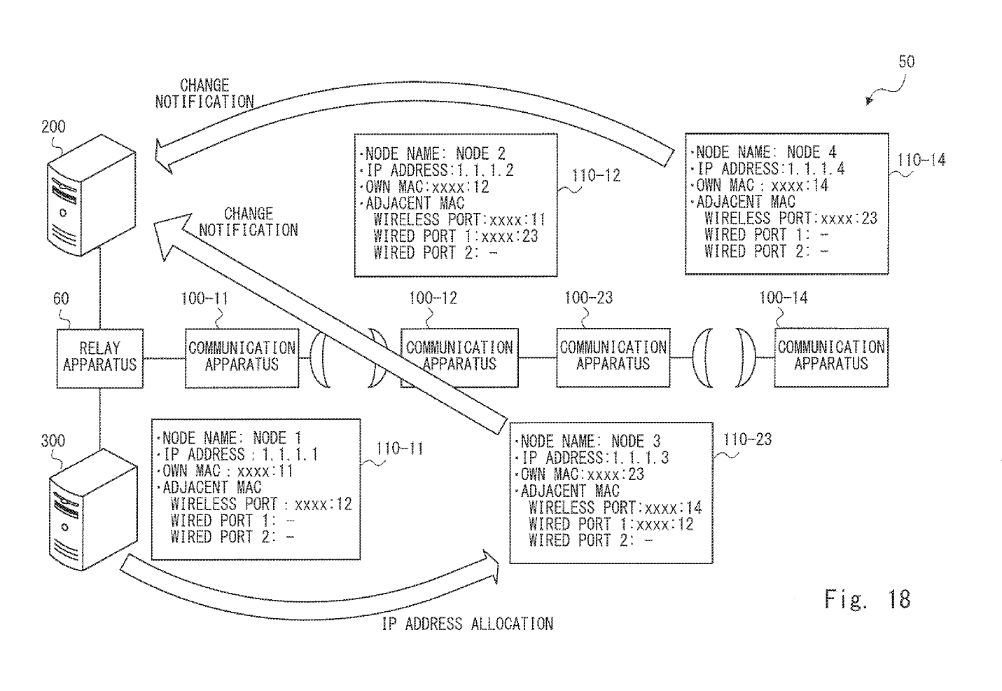

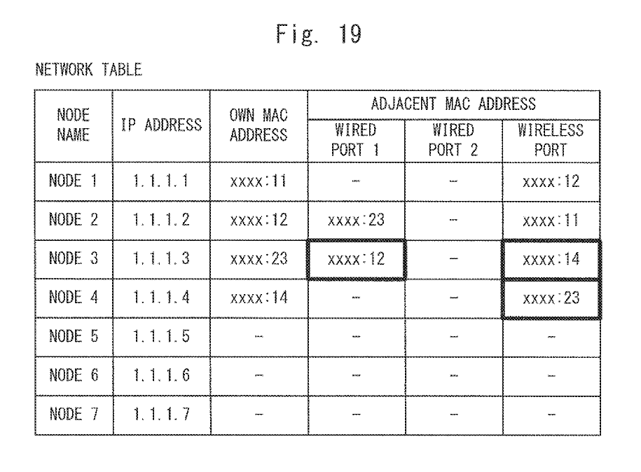

FIG. 17 is a sequence diagram showing a process flow for allocating the IP address to the communication apparatus 100 added in FIG. 13. FIG. 18 is a diagram schematically showing a state in which the IP address is allocated to the communication apparatus 100 added in FIG. 13. Further, FIG. 19 is a diagram illustrating the network table in the examples shown in FIGS. 17 and 18.

The communication apparatus 100-23 sends a request for the IP address to be allocated to the communication apparatus 100-23 (S150). Specifically, when the communication apparatus 100-23 is communicatively connected to the communication apparatus 100-12, which is adjacent to the communication apparatus 100-23, the communication apparatus 100-23 transmits a request that is in compliant with the DHCP (the DHCP request) to the DHCP server 300. More specifically, the communication apparatus 100-23 transmits the DHCP request in which the address of the DHCP server 300 is set as the destination address and the address of the communication apparatus 100-23 (e.g., the MAC address) is set as the transmission source address to the communication apparatus 100-12. The communication apparatus 100-12 forwards the DHCP request to the network on the side of the DHCP server 300 (i.e., the communication apparatus 100-11). In a similar way, the communication apparatus 100-11 forwards the DHCP request to the relay apparatus 60. Further, the relay apparatus 60 forwards the DHCP request to the DHCP server 300. In this way, the DHCP request from the communication apparatus 100-23 is transmitted to the DHCP server 300 and the allocation request reception unit 310 of the DHCP server 300 receives the DHCP request including the MAC address “xxxx:23”.

When the DHCP server 300 receives the DHCP request from the communication apparatus 100-23, the DHCP server 300 allocates the IP address to the communication apparatus 100-23 (S152). Specifically, the allocation processing unit 312 of the DHCP server 300 determines that the transmission source address of the DHCP request indicates the MAC address “xxxx:23”. Accordingly, the allocation processing unit 312 performs processing for allocating the IP address “1.1.1.3” associated with the MAC address “xxxx:23” in the allocation information to the communication apparatus 100-23.

It is not until the synchronization processing in S142 stated above is performed that the IP address “1.1.1.3” is associated with the MAC address “xxxx:23” in the allocation information. Accordingly, the allocation processing unit 312 performs processing for allocating the IP address “1.1.1.3” to the communication apparatus 100-23 after the synchronization processing in S140 is performed, that is, after the allocation information is updated. When the DHCP request is regularly transmitted from the communication apparatus 100-23, the DHCP server 300 may discard the DHCP request that has been received before the synchronization processing in S142 stated above is performed.

As a method of allocating the IP addresses, a switch function included in each of the communication apparatuses 100 may be, for example, used. In this case, the DHCP server 300 transmits a DHCP packet that is destined for the address of the communication apparatus 100-23 (e.g., the MAC address) and indicates that the IP address “1.1.1.3” will be allocated, to the communication apparatus 100-11 via the relay apparatus 60. The communication apparatus 100-11 forwards the DHCP packet to the communication apparatus 100-12. The communication apparatus 100-12 forwards the DHCP packet to the communication apparatus 100-23 (and the communication apparatus 100-11). In this way, the communication apparatus 100-23 receives the DHCP packet. The communication apparatus 100-23 sets the IP address of the communication apparatus 100-23 to “1.1.1.3” using the DHCP packet. Further, the communication apparatus 100-23 updates the management information 110-23 stored in the communication apparatus 100-23.

Further, a router function included in each of the communication apparatuses 100 may be used. In this case, each of the communication apparatuses 100 is assumed to be a DHCP relay server, whereby the IP address is allocated to the communication apparatus 100-23. Specifically, in the DHCP request from the communication apparatus 100-23, the destination address is a broadcast address. The communication apparatus 100-12 converts, in the DHCP request from the communication apparatus 100-23, the destination address into the address of the DHCP server 300, converts the transmission source address into the IP address of the communication apparatus 100-12, and transmits this request to the DHCP server 300. The DHCP server 300 transmits the DHCP packet that is destined for the IP address of the communication apparatus 100-12 and indicates that the IP address “1.1.1.3” will be allocated to the MAC address “xxxx:23”. The communication apparatus 100-12 that has received the DHCP packet converts the destination IP address into “0.0.0.0” in the DHCP packet. Further, the communication apparatus 100-12 encapsulates the DHCP packet into the frame destined for the MAC address of the communication apparatus 100-23 that has sent the DHCP request and sends this packet to the communication apparatus 100-23. Accordingly, the communication apparatus 100-23 sets the IP address of the communication apparatus 100-23 to “1.1.1.3”.

When the IP address is set, the communication apparatus 100-23 transmits the change notification to the NMS server 200 (S154). In the processing in S122, the adjacent MAC address of the management information 110-23 has been changed. Accordingly, the communication apparatus 100-23 generates the adjacent change information indicating that the communication apparatus 100 of the MAC address “xxxx:12” has been connected to the wired port 1. The adjacent change information is indicated, for example, as “wired port 1:MAC address “xxxx:12” added”. Further, the communication apparatus 100-23 generates the adjacent change information indicating that the communication apparatus 100 of the MAC address “xxxx:14” has been connected to the wireless port. The adjacent change information is indicated, for example, as “wireless port:MAC address “xxxx:14” added”. In this case, the transmission source address in the change notification may be the IP address “1.1.1.3” allocated to the communication apparatus 100-23.

Further, the communication apparatus 100-23 transmits the change notification including the adjacent change information that has been generated to the communication apparatus 100-12, which is adjacent to the communication apparatus 100-23. The communication apparatus 100-12 forwards, similar to the operation in the communication apparatus 100-11 in S104, the change notification to the communication apparatus 100-11. The communication apparatus 100-11 forwards the change notification to the relay apparatus 60. The relay apparatus 60 forwards the change notification to the NMS server 200. In this way, the change notification generated by the communication apparatus 100-23 is transmitted to the NMS server 200.

In a similar way, since the communication apparatus 100-14 is now able to perform the network communication with the communication apparatus 100-23, the communication apparatus 100-14 transmits the change notification to the NMS server 200 (S156). In the processing of S132, the adjacent MAC address is changed. That is, in the management information 110-14, the adjacent MAC address has been changed. Accordingly, the communication apparatus 100-14 generates adjacent change information indicating that the communication apparatus 100 of the MAC address “xxxx:23” has been connected to the wireless port. The adjacent change information is indicated, for example, as “wireless port:MAC address “xxxx:23” added”.

Further, the communication apparatus 100-14 transmits the change notification including the adjacent change information that has been generated to the communication apparatus 100-23, which is adjacent to the communication apparatus 100-14. The communication apparatus 100-23 forwards, similar to the operation in the communication apparatus 100-11 in S104, the change notification to the communication apparatus 100-12. The communication apparatus 100-12 forwards the change notification to the communication apparatus 100-11. The communication apparatus 100-11 forwards the change notification to the relay apparatus 60. The relay apparatus 60 forwards the change notification to the NMS server 200. In this way, the change notification generated by the communication apparatus 100-14 is transmitted to the NMS server 200.

When the NMS server 200 receives the change notification from the communication apparatus 100-23 and the communication apparatus 100-14, the NMS server 200 updates the network information (S158). Specifically, the update unit 206 of the NMS server 200 determines that the adjacent change information has been generated by the communication apparatus 100-23 (the apparatus of the MAC address “xxxx:23”) from the transmission source address (e.g., the IP address “1.1.1.3”) included in the change notification from the communication apparatus 100-23 and the network information. Then the update unit 206 determines, based on the adjacent change information, that the communication apparatus 100 of the MAC address “xxxx:14” has been connected to the wireless port and the communication apparatus 100 of the MAC address “xxxx:12” has been connected to the wired port 1. The update unit 206 determines, based on the network information, that the node corresponding to the communication apparatus 100 of the MAC address “xxxx:23” is the “node 3”. Accordingly, as shown in FIG. 19, the update unit 206 associates the MAC address “xxxx:12” with the “wired port 1” of the “node 3” and associates the MAC address “xxxx:14” with the “wireless port” in the network table.

In a similar way, the update unit 206 of the NMS server 200 determines, from the transmission source address included in the change notification from the communication apparatus 100-14 (e.g., the IP address “1.1.1.4”) and the network information, that the adjacent change information has been generated by the communication apparatus 100-14 (the apparatus of the MAC address “xxxx:14”). Then the update unit 206 determines, from the adjacent change information, that the communication apparatus 100 of the MAC address “xxxx:23” has been connected to the wireless port. The update unit 206 determines, from the network information, that the node corresponding to the communication apparatus 100 of the MAC address “xxxx:14” is the “node 4”. Accordingly, as shown in FIG. 19, the update unit 206 associates the MAC address “xxxx:23” with the “wireless port” of the “node 4” in the network table.

When the network information is updated, similar to the processing in S138, the NMS server 200 causes the network information that has been updated to be displayed (S160). Specifically, when the display unit 210 of the NMS server 200 accepts the information indicating that the network information has been updated from the management unit 202, the display unit 210 displays the network table illustrated in FIG. 19. Accordingly, the user (the administrator) of the NMS server 200 is able to confirm that the adjacent MAC addresses regarding the node 3 and the node 4 have been updated.

When one communication apparatus 100 is replaced by another communication apparatus 100, the user often desires that the IP address allocated to the communication apparatus 100 before the replacement be allocated to the communication apparatus 100 after the replacement as well. In this exemplary embodiment, in the network information managed by the NMS server 200, the respective nodes and the respective IP addresses are associated with each other. Further, in the network information, the MAC addresses of the communication apparatuses 100 are associated with the respective nodes and the respective IP addresses. When one communication apparatus 100 is replaced by the other communication apparatus 100, the NMS server 200 replaces the MAC address of the communication apparatus 100 before the replacement by the MAC address of the communication apparatus 100 after the replacement in the network information. In other words, the NMS server 200 associates the MAC address of the communication apparatus 100 after the replacement with the node corresponding to the communication apparatus 100 before the replacement.

In the aforementioned example, in the network information, the “node 3” is associated with the IP address “1.1.1.3” and the MAC address “xxxx:13” of the communication apparatus 100 before the replacement (communication apparatus 100-13) is further associated with the “node 3” and the IP address “1.1.1.3”. When the communication apparatus 100-13 is replaced by the communication apparatus 100-23, the NMS server 200 receives, from the communication apparatus 100-12, which is adjacent to the communication apparatus 100-23, the change notification indicating that the communication apparatus 100 of the MAC address “xxxx:13” has been deleted and that the communication apparatus 100 of the MAC address “xxxx:23” is provided in place of the communication apparatus 100-13 as the apparatus adjacent to the communication apparatus 100-12. Accordingly, the NMS server 200 changes the own MAC address corresponding to the “node 3” from “xxxx:13” to “xxxx:23”.

Accordingly, when one communication apparatus 100 is replaced by another communication apparatus 100, the NMS server 200 is able to update the MAC address corresponding to the node to be replaced (in the aforementioned example, the node 3) using the network information without requiring any user's operation. Further, the NMS server 200 synchronizes the network information with the allocation information stored in the DHCP server 300, whereby the allocation information can be updated. Therefore, the IP address that has been associated with the node to be replaced in advance (i.e., the IP address that has been allocated to the communication apparatus 100 before the replacement) is allocated to the MAC address of the communication apparatus 100 after the replacement. Accordingly, it becomes possible to allocate the IP address to the communication apparatus 100 after the replacement as desired by the user.

Further, the change notification transmitted from the apparatus adjacent to the communication apparatus 100 after the replacement is packet forwarded in each of the communication apparatuses 100 provided before the NMS server 200. Since the packet forwarding does not require complicated processing such as replacement of the destination address or the like, the processing in each of the communication apparatuses 100 is simple. Accordingly, in this exemplary embodiment, it becomes possible to allocate the IP address to the communication apparatus 100 after the replacement in a simpler way.

Next, a case in which one communication apparatus 100 is newly installed will be described. Specifically, a case in which a communication apparatus 100 is newly installed in a position where no communication apparatus 100 has been installed will be described.

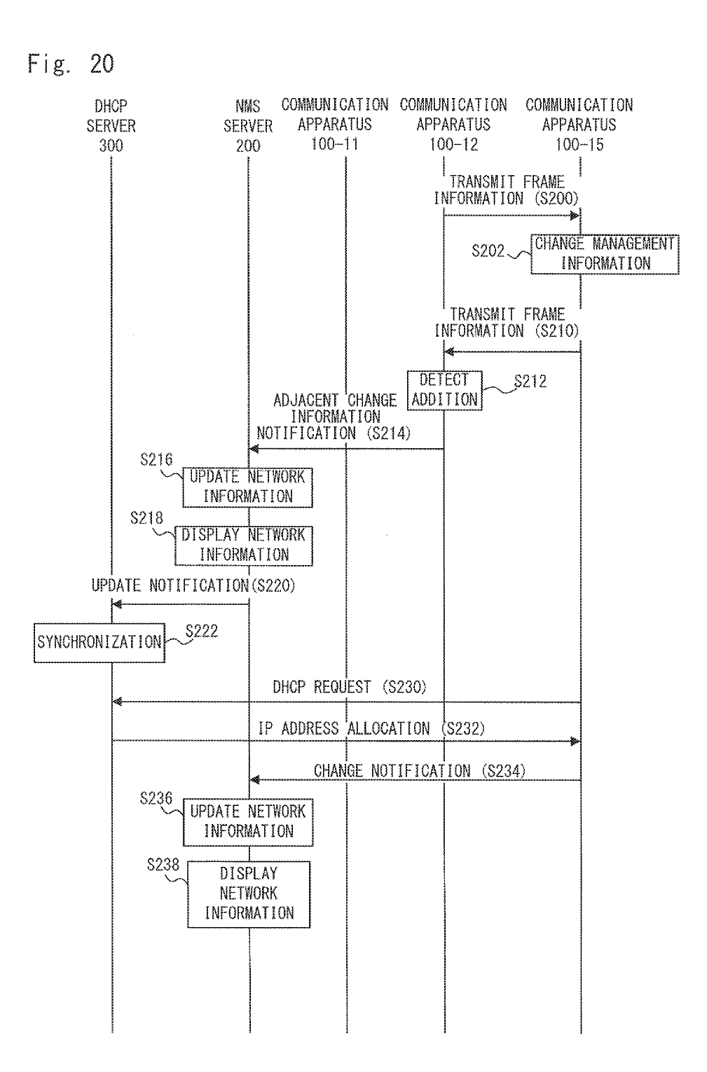

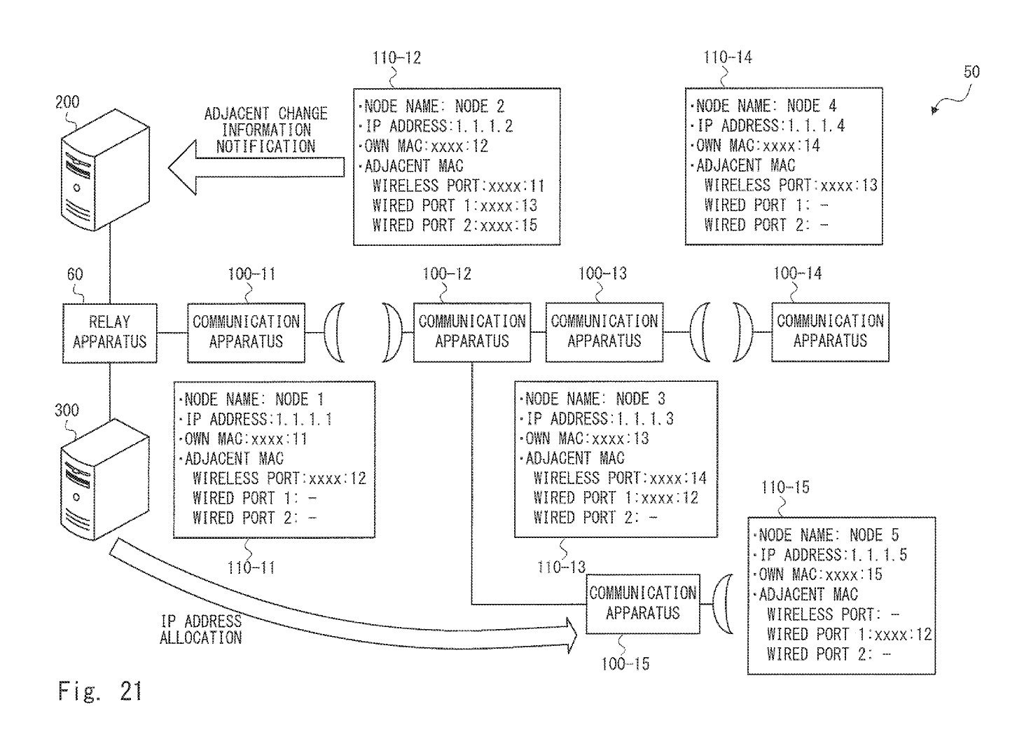

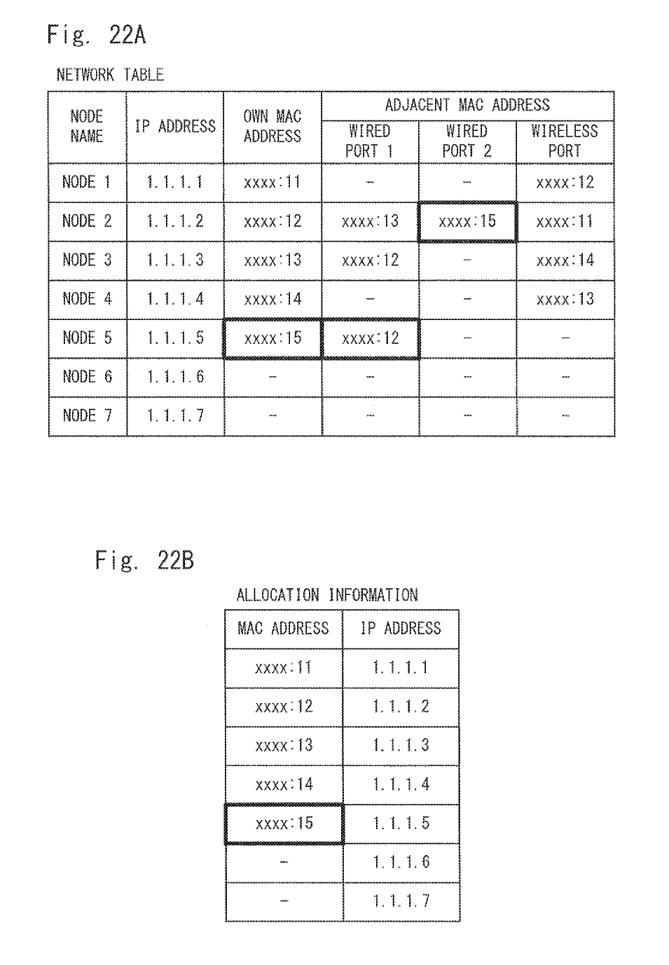

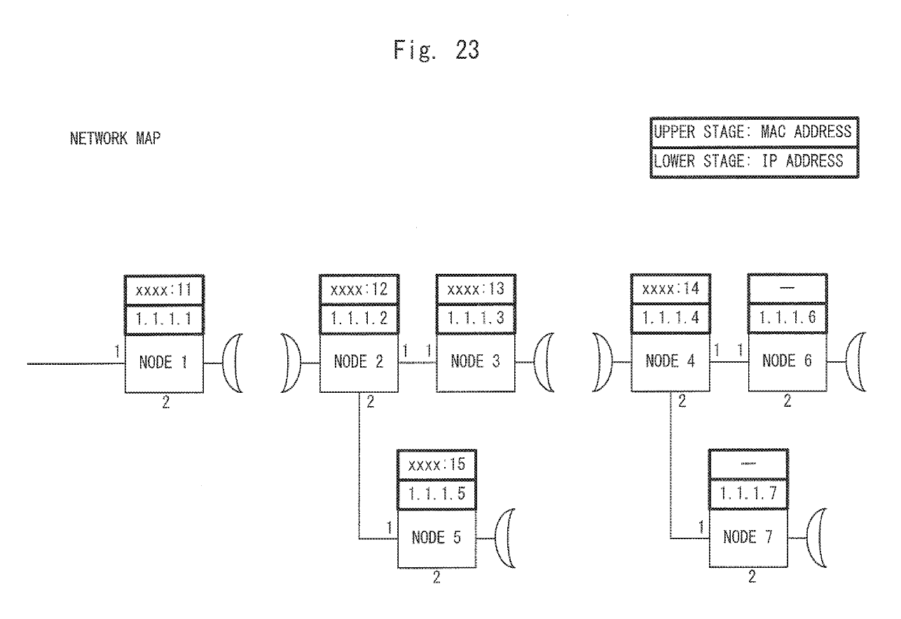

FIG. 20 is a sequence diagram showing a process flow in the communication system 50 when one communication apparatus 100 is newly installed in the first exemplary embodiment. Further, FIG. 21 is a diagram schematically showing a state in which one communication apparatus 100 is newly installed. FIGS. 20 and 21 illustrate a case in which a communication apparatus 100-15 is newly installed. Further, FIGS. 22A, 22B, and 23 are diagrams illustrating the network information and the allocation information in the examples of FIGS. 20 and 21, FIG. 22A illustrates the network table, FIG. 22B illustrates the allocation information, and FIG. 23 illustrates the network map.

In the first exemplary embodiment, the communication apparatus 100-15 is connected to the wired port 2 of the communication apparatus 100-12 via the wired port 1. Further, the MAC address of the communication apparatus 100-15 is “xxxx:15”. Further, the communication apparatus 100-15 stores the management information 110-15 indicating “xxxx:15” as the MAC address of the communication apparatus 100-15.

When the communication apparatus 100-15 is installed, the communication apparatus 100-12 transmits the frame information to the communication apparatus 100-15, which is adjacent to the communication apparatus 100-12, at regular time intervals (S200). Specifically, when the communication apparatus 100-15 is installed, the communication apparatus 100-12 transmits the frame information including the MAC address “xxxx:12” of the communication apparatus 100-12 to the communication apparatus 100-15 at regular time intervals.

Accordingly, the communication apparatus 100-15 changes, as shown in FIG. 21, the management information 110-15 stored in the communication apparatus 100-15 (S202). Specifically, the communication apparatus 100-15 associates, as shown in FIG. 21, the MAC address “xxxx:12” with the wired port 1 in the management information 110-15 stored in the communication apparatus 100-15. In this case, the IP address is not allocated to the communication apparatus 100-15. Therefore, the communication apparatus 100-15 cannot communicate with the NMS server 200. Accordingly, the communication apparatus 100-15 does not transmit the change notification.

Further, when the communication apparatus 100-15 is installed, the communication apparatus 100-15 transmits the frame information including the MAC address “xxxx-15” of the communication apparatus 100-15 to the communication apparatus 100-12, which is adjacent to the communication apparatus 100-15, at regular time intervals (S210). When the communication apparatus 100-12 receives the frame information from the communication apparatus 100-15, the communication apparatus 100-12 detects that the communication apparatus 100-15 has been added as the adjacent apparatus (S212).

Specifically, when the communication apparatus 100-12 receives the frame information via the wired port 2 in a state in which the adjacent apparatus is not connected to the communication apparatus 100-12 via the wired port 2, the communication apparatus 100-12 detects that the communication apparatus 100 has been added to the wired port 2. In other words, when the communication apparatus 100-12 receives the frame information via the wired port 2 in a state in which the adjacent MAC address is not associated with the wired port 2 in the management information 110-12, the communication apparatus 100-12 detects that the communication apparatus 100 has been added to the wired port 2. In this case, the communication apparatus 100-12 associates, as shown in FIG. 21, the MAC address “xxxx:15” with the wired port 2 in the management information 110-12 stored in the communication apparatus 100-12. That is, the communication apparatus 100-12 changes the management information 110-12.

The communication apparatus 100-12 notifies the NMS server 200 of the adjacent change information indicating that the adjacent apparatus has been changed (S214). Specifically, the communication apparatus 100-12 generates the adjacent change information indicating that the communication apparatus 100-15 has been added. More specifically, the adjacent change information generated in this case indicates that the communication apparatus 100 of the MAC address “xxxx:15” has been connected to the wired port 2. The adjacent change information is indicated, for example, as “wired port 2:MAC address “xxxx:15” added”.

Further, similar to S104 and the like in FIG. 9, the communication apparatus 100-12 transmits the change notification indicating the adjacent change information that has been generated to the communication apparatus 100-11, which is adjacent to the communication apparatus 100-12. The communication apparatus 100-11 forwards the change notification to the relay apparatus 60. The relay apparatus 60 forwards the change notification to the NMS server 200. In this way, the adjacent change information generated by the communication apparatus 100-12 is sent to the NMS server 200.

When the NMS server 200 receives the change notification, the NMS server 200 updates the network information (S216). Specifically, the update unit 206 of the NMS server 200 determines, from the transmission source address included in the change notification (e.g., IP address “1.1.1.2”) and the network information, that the adjacent change information has been generated by the communication apparatus 100-12 (the apparatus of the MAC address “xxxx:12”). Then the update unit 206 determines, based on the adjacent change information, that the communication apparatus 100 has been connected to the wired port 2. The update unit 206 determines, based on the network information, that the node corresponding to the communication apparatus 100 of the MAC address “xxxx:12” is the “node 2”. Accordingly, as shown in FIG. 22A, the update unit 206 associates the MAC address “xxxx:15” with the “wired port 2” of the “node 2” in the network table.

Further, the update unit 206 determines that the node connected to the “wired port 2” of the “node 2” is the “node 5” using the network information. Therefore, as shown in FIG. 22A, the update unit 206 associates the MAC address “xxxx:15” with the “node 5” in the network table. Further, as shown in FIG. 23, the update unit 206 associates the MAC address “xxxx:15” with the node 5 in the network map. In this way, the update unit 206 is able to accurately associate the MAC address of the communication apparatus 100-15 that is newly installed with the node 5 that is adjacent to the node 2 corresponding to the communication apparatus 100-12, which is adjacent to the communication apparatus 100-15.

When the network information is updated, similar to the processing of S138, the NMS server 200 causes the network information that has been updated to be displayed (S218). Specifically, when the display unit 210 of the NMS server 200 accepts the information indicating that the network information has been updated from the management unit 202, the display unit 210 causes at least one of the network table illustrated in FIG. 22A and the network map illustrated in FIG. 23 to be displayed. Accordingly, the user (the administrator) of the NMS server 200 is able to confirm that the communication apparatus 100 corresponding to the node 5 has been added. At this time, the NMS server 200 has not yet received the change notification from the communication apparatus 100-15 corresponding to the node 5. Therefore, in the network table displayed in S218, the field of the “wired port 1” of the adjacent MAC address of the node 5 is blank.

Next, the NMS server 200 transmits the network information update notification to the DHCP server 300 (S220). Accordingly, the DHCP server 300 synchronizes the allocation information with the network information (S222). Specifically, the synchronization processing unit 208 of the NMS server 200 transmits the network information update notification indicating that the MAC address “xxxx:15” has been associated with the IP address “1.1.1.5” to the DHCP server 300. Accordingly, as shown in FIG. 22B, the allocation information update unit 306 of the DHCP server 300 associates the MAC address “xxxx:15” with the IP address “1.1.1.5” in the allocation information. Accordingly, the allocation information is synchronized with the network information.

The communication apparatus 100-15 sends a request for the IP address to be allocated to the communication apparatus 100-15 (S230). Specifically, when the communication apparatus 100-15 is communicatively connected to the communication apparatus 100-12, which is adjacent to the communication apparatus 100-15, the communication apparatus 100-15 transmits the DHCP request to the DHCP server 300. More specifically, the communication apparatus 100-15 transmits, to the communication apparatus 100-12, the DHCP request in which the address of the DHCP server 300 is set as the destination address and the address of the communication apparatus 100-15 (the MAC address) is set as the transmission source address. The communication apparatus 100-12 forwards the DHCP request to the network on the side of the DHCP server 300 (that is, the communication apparatus 100-11). In a similar way, the communication apparatus 100-11 forwards the DHCP request to the relay apparatus 60. Further, the relay apparatus 60 forwards the DHCP request to the DHCP server 300. In this way, the DHCP request from the communication apparatus 100-15 is transmitted to the DHCP server 300 and the allocation request reception unit 310 of the DHCP server 300 receives the DHCP request including the MAC address “xxxx:15”.

When the DHCP server 300 receives the DHCP request from the communication apparatus 100-15, the DHCP server 300 allocates the IP address to the communication apparatus 100-15 (S232). Specifically, the allocation processing unit 312 of the DHCP server 300 determines that the transmission source address of the DHCP request indicates the MAC address “xxxx:15”. Accordingly, the allocation processing unit 312 performs processing for allocating the IP address “1.1.1.5” associated with the MAC address “xxxx:15” in the allocation information to the communication apparatus 100-15.

It is not until the synchronization processing in S222 stated above is performed when the IP address “1.1.1.5” is associated with the MAC address “xxxx:15” in the allocation information. Accordingly, the allocation processing unit 312 performs processing for allocating the IP address “1.1.1.5” to the communication apparatus 100-15 after the synchronization processing in S222 is performed, that is, after the allocation information is updated. When the DHCP request is regularly transmitted from the communication apparatus 100-15, the DHCP server 300 may discard the DHCP request received before the synchronization processing in S222 stated above is performed.

When the IP address is set, the communication apparatus 100-15 transmits the change notification to the NMS server 200 (S234). In the processing in S202, the adjacent MAC address of the management information 110-15 has been changed. Accordingly, the communication apparatus 100-15 generates the adjacent change information indicating that the communication apparatus 100 of the MAC address “xxxx:12” has been connected to the wired port 1. The adjacent change information is indicated, for example, as “wired port 1:MAC address “xxxx:12” added”. In this case, the transmission source address in the change notification may be the IP address “1.1.1.5” allocated to the communication apparatus 100-15. Further, the communication apparatus 100-15 transmits the change notification including the adjacent change information that has been generated to the communication apparatus 100-12, which is adjacent to the communication apparatus 100-15. Similar to the operation in S154 stated above, the change notification generated by the communication apparatus 100-14 is transmitted to the NMS server 200 via the communication apparatus 100-11 and the relay apparatus 60.

When the NMS server 200 receives the change notification from the communication apparatus 100-15, the NMS server 200 updates the network information, similar to the processing in S158 and the like (S236). The update unit 206 of the NMS server 200 associates, as shown in FIG. 22A, the MAC address “xxxx:12” with the “wired port 1” of the “node 5” in the network table. When the network information is updated, similar to the processing in S160, S138 and the like, the NMS server 200 causes the network information that has been updated to be displayed (S238). Specifically, the display unit 210 of the NMS server 200 displays the network table illustrated in FIG. 22A. The user (the administrator) of the NMS server 200 is therefore able to confirm that the adjacent MAC address regarding the node 5 has been updated.

When a communication apparatus 100 is newly installed in a state in which the user constructs the network structure shown in FIG. 6 in advance, the user desires that the specific IP address in accordance with the network structure be allocated to the communication apparatus 100 that has been newly installed. In this exemplary embodiment, in the network information managed by the NMS server 200, the IP address is associated with the node corresponding to the position in which no communication apparatus 100 is installed in advance. When the communication apparatus 100 is newly installed, the NMS server 200 associates the MAC address of the communication apparatus 100 that is newly installed with the node corresponding to the position in which the communication apparatus 100 has been newly installed in the network information.

In the aforementioned example, while the communication apparatus 100 is not installed in the position corresponding to the node 5, the IP address “1.1.1.5” is associated with the node 5 in advance. In this case, when the communication apparatus 100-15 is newly installed in the position corresponding to the node 5, the user desires that the IP address “1.1.1.5” associated with the node 5 in advance be allocated to the communication apparatus 100-15. In this exemplary embodiment, when the communication apparatus 100-15 is newly installed in the position corresponding to the node 5, the NMS server 200 receives, from the communication apparatus 100-12 adjacent to the communication apparatus 100-15, the change notification indicating that the communication apparatus 100 of the MAC address “xxxx:15” has been added as an apparatus adjacent to the communication apparatus 100-12. Accordingly, the NMS server 200 associates the MAC address “xxxx:15” with the “node 5”.

Accordingly, when one communication apparatus 100 is newly installed, the NMS server 200 is able to update, without requiring any user's operation, the MAC address corresponding to the node to be installed (in the aforementioned example, the node 5) using the network information. Further, as stated above, the NMS server 200 synchronizes the network information with the allocation information stored in the DHCP server 300, whereby it is possible to update the allocation information. Accordingly, the IP address associated with the node corresponding to the position in which the communication apparatus 100 is newly installed in advance is allocated to the MAC address of the communication apparatus 100 that is newly installed. It is therefore possible to allocate the IP address to the communication apparatus 100 that has been newly installed as desired by the user.

Further, in the aforementioned exemplary embodiment, the NMS server 200 synchronizes the network information with the allocation information, whereby the NMS server 200 and the DHCP server 300 are configured to cooperate with each other. Further, in the network information, the respective IP addresses and the respective MAC addresses are associated with each other. Accordingly, by only changing the configuration of the NMS server 200 from the existing one to the components according to this exemplary embodiment, this exemplary embodiment can be achieved by using the universal DHCP server 300 and the universal communication apparatus 100 (NE). Further, the NMS server 200 manages the network information using the MAC address, whereby the communication apparatus 100 is able to use the universal LLDP as means for detecting the adjacent apparatus. Further, the communication apparatus 100 is able to use the universal SNMP as means for transmitting the change notification regarding the adjacent apparatus to the NMS server 200. That is, the configuration according to this exemplary embodiment can be achieved in a simple manner using the existing protocol.

### Modified Examples

The present invention is not limited to the aforementioned exemplary embodiments and may be changed as appropriate without departing from the spirit of the present invention. In the aforementioned sequence, for example, the order of the processes (steps) may be changed as appropriate. Further, one or more of the plurality of processes (steps) may be omitted.

For example, in FIG. 9, the process of displaying the network information in S108 may be performed after the process of S110. Further, the process of S108 may be performed in a desired timing. The same is applicable to S138 of FIG. 13, S218 of FIG. 20 etc. Further, in FIG. 13, the processes of S120 and S122 may be performed in a desired timing between S130 and S156. In a similar way, in FIG. 20, the processes of S200 and S202 may be performed in a desired timing between S210 and S234.

In the aforementioned exemplary embodiments, the MAC address is used as the apparatus identification information that identifies the communication apparatus 100. Further, the MAC address of the communication apparatus 100 that has been added is included in the change notification, and the nodes, the IP addresses, and the MAC addresses are associated with one another in the network information. However, the apparatus identification information is not limited to the MAC address. The apparatus identification information may be other than the MAC address and may be apparatus identification information (a physical address) capable of uniquely identifying the communication apparatus 100. The serial number, the name or the like of the communication apparatus 100 may be, for example, used. On the other hand, in the universal DHCP server, the MAC addresses and the IP addresses are associated with each other. Therefore, by using the MAC addresses, the exemplary embodiments may be achieved in a simpler way using the universal DHCP server.

Further, in the aforementioned exemplary embodiments, the DHCP server 300 (allocation server) allocates the IP addresses and the IP addresses are associated with the respective nodes of the communication apparatuses 100 in advance. However, the IP address is not the only one that the DHCP server 300 (allocation server) can allocate. The IP address is one example of the network parameter used in the network communication and any other desired network parameter may be allocated by the DHCP server 300.

While the NMS server 200 and the DHCP server 300 have been separately provided in the aforementioned exemplary embodiments, the present invention is not limited to this configuration. One apparatus may have the function of the NMS server 200 and the function of the DHCP server 300. On the other hand, it is not necessary that all the components of the NMS server 200 be implemented by a physically single apparatus. That is, the NMS server 200 may be physically composed of a plurality of apparatuses. The same is applicable to the DHCP server 300.

Further, in the aforementioned exemplary embodiments, the communication apparatus 100 generates the adjacent change information when the adjacent apparatus is changed (deleted or added). However, in such cases, the communication apparatus 100 may not generate the adjacent change information. The communication apparatus 100 may transmit the management information 110 that has been changed to the NMS server 200. That is, “the change notification” also contains the management information transmitted when the adjacent apparatus is changed.

Further, while the display unit 210 displays the network information when the network information is updated in the aforementioned exemplary embodiments, the present invention is not limited to this configuration. The display unit 210 may display the network information to be updated before the network information is actually updated. Further, the display unit 210 may display both the network information before the update and the network information after the update.

In the above examples, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present invention has been described above with reference to the exemplary embodiments, the present invention is not limited to the above exemplary embodiments. Various changes that may be understood by those skilled in the art may be made on the configurations and the details of the present invention within the scope of the present invention.

This application is based upon and claims the benefit of priority from Japanese Patent Application No. 2014-194985, filed on Sep. 25, 2014, the disclosure of which is incorporated herein in its entirety by reference.

### REFERENCE SIGNS LIST

1 COMMUNICATION SYSTEM
10 COMMUNICATION APPARATUS
20 MANAGEMENT SERVER
22 MANAGEMENT UNIT
24 RECEPTION UNIT
26 UPDATE UNIT
50 COMMUNICATION SYSTEM
100 COMMUNICATION APPARATUS
110 MANAGEMENT INFORMATION
200 NMS SERVER
202 MANAGEMENT UNIT
204 CHANGE NOTIFICATION RECEPTION UNIT
206 UPDATE UNIT
208 SYNCHRONIZATION PROCESSING UNIT
210 DISPLAY UNIT
212 INPUT UNIT
300 DHCP SERVER
302 ALLOCATION INFORMATION STORAGE UNIT
304 UPDATE NOTIFICATION RECEPTION UNIT
306 ALLOCATION INFORMATION UPDATE UNIT
310 ALLOCATION REQUEST RECEPTION UNIT
312 ALLOCATION PROCESSING UNIT

1. A management server comprising:
at least one memory storing instructions, and
at least one processor configured to execute the instructions to:
manage network information indicating a network structure composed of a plurality of nodes, network parameters associated with the plurality of respective nodes in advance, and apparatus identification information that identifies communication apparatuses corresponding to the plurality of respective nodes;
receive, from a second communication apparatus, a change notification indicating that a first communication apparatus corresponding to a first node among the plurality of nodes has been changed, the second communication apparatus corresponding to a second node that is adjacent to the first node; and
update information regarding the first node in the network information using the change notification.

2. The management server according to claim 1, wherein the at least one processor is further configured to execute the instructions to associate the apparatus identification information of the first communication apparatus corresponding to the first node with the network parameter associated with the first node.

3. The management server according to claim 2, wherein the at least one processor is further configured to execute the instructions to perform processing for synchronizing the network information in which the apparatus identification information is associated with the network parameter with allocation information stored in an allocation server that allocates the network parameter to the communication apparatus.

4. The management server according to claim 1, wherein:
the change notification indicates at least an address of the second communication apparatus and a connection port to which the first communication apparatus is connected in the second communication apparatus, and
the at least one processor is further configured to execute the instructions to update information regarding the first node using the change notification and the network information.

5. The management server according to claim 1, wherein:
the at least one processor is further configured to execute the instructions to receive, from the second communication apparatus, the change notification indicating that the first communication apparatus has been deleted; and
the at least one processor is further configured to execute the instructions to delete the apparatus identification information associated with the first node in the network information.

6. The management server according to claim 1, wherein:
the at least one processor is further configured to execute the instructions to receive, from the second communication apparatus, a change notification indicating that the first communication apparatus has been added to the position corresponding to the first node; and
the at least one processor is further configured to execute the instructions to associate the apparatus identification information of the first communication apparatus with the first node in the network information.

7. The management server according to claim 1, wherein the network parameter is an IP address and the apparatus identification information is a MAC address.

8.-10. (canceled)

11. A communication system comprising:
a plurality of communication apparatuses; and
a management server configured to manage a network composed of the plurality of communication apparatuses,
wherein the management server comprises:
at least one memory storing instructions, and
at least one processor configured to execute the instructions to:
manage network information indicating a network structure composed of a plurality of nodes, network parameters associated with the plurality of respective nodes in advance, and apparatus identification information that identifies communication apparatuses corresponding to the plurality of respective nodes;
receive, from a second communication apparatus among the plurality of communication apparatuses, a change notification indicating that a first communication apparatus among the plurality of communication apparatuses corresponding to a first node among the plurality of nodes has been changed, the second communication apparatus corresponding to a second node adjacent to the first node; and
update information regarding the first node in the network information using the change notification.

12. The communication system according to claim 11, wherein the at least one processor is further configured to execute the instructions to associate the apparatus identification information of the first communication apparatus corresponding to the first node with the network parameter associated with the first node.

13. The communication system according to claim 12, further comprising an allocation server configured to allocate the network parameter to the communication apparatus,
wherein the at least one processor is further configured to execute the instructions to perform processing for synchronizing the network information in which the apparatus identification information is associated with the network parameter with allocation information stored in the allocation server.

14. The communication system according to claim 11, wherein:
the change notification indicates at least an address of the second communication apparatus and a connection port to which the first communication apparatus is connected in the second communication apparatus, and
the at least one processor is further configured to execute the instructions to update information regarding the first node using the change notification and the network information.

15. The communication system according to claim 11, wherein:
the at least one processor is further configured to execute the instructions to receive, from the second communication apparatus, the change notification indicating that the first communication apparatus has been deleted; and
the at least one processor is further configured to execute the instructions to delete the apparatus identification information associated with the first node in the network information.

16. The communication system according to claim 11, wherein:
the at least one processor is further configured to execute the instructions to receive, from the second communication apparatus, a change notification indicating that the first communication apparatus has been added to the position corresponding to the first node; and
the at least one processor is further configured to execute the instructions to associate the apparatus identification information of the first communication apparatus with the first node in the network information.

17. The communication system according to claim 11, wherein the network parameter is an IP address and the apparatus identification information is a MAC address.

18. A network management method comprising:
managing network information indicating a network structure composed of a plurality of nodes, network parameters associated with the plurality of respective nodes in advance, and apparatus identification information that identifies communication apparatuses corresponding to the plurality of respective nodes;
receiving, from a second communication apparatus, a change notification indicating that a first communication apparatus corresponding to a first node among the plurality of nodes has been changed, the second communication apparatus corresponding to a second node that is adjacent to the first node; and
updating information regarding the first node in the network information using the change notification.

19. The network management method according to claim 18, comprising associating apparatus identification information of a first communication apparatus corresponding to the first node with a network parameter associated with the first node.

20. The network management method according to claim 19, comprising performing processing for synchronizing the network information in which the apparatus identification information is associated with the network parameter with allocation information stored in an allocation server that allocates the network parameter to the communication apparatus.

21. The network management method according to claim 18, wherein:
the change notification indicates at least an address of the second communication apparatus and a connection port to which the first communication apparatus is connected in the second communication apparatus, and
information regarding the first node is updated using the change notification and the network information.

22. The network management method according to claim 18, comprising:
receiving, from the second communication apparatus, the change notification indicating that the first communication apparatus has been deleted; and
deleting the apparatus identification information associated with the first node in the network information.

23. The network management method according to claim 18, comprising:
receiving, from the second communication apparatus, a change notification indicating that the first communication apparatus has been added to the position corresponding to the first node; and
associating the apparatus identification information of the first communication apparatus with the first node in the network information.

24. The network management method according to claim 18, wherein the network parameter is an IP address and the apparatus identification information is a MAC address.

25. A non-transitory computer readable medium storing a program for causing a computer to achieve the following functions of:
managing network information indicating a network structure composed of a plurality of nodes, network parameters associated with the plurality of respective nodes in advance, and apparatus identification information that identifies communication apparatuses corresponding to the plurality of respective nodes;
receiving, from a second communication apparatus, a change notification indicating that a first communication apparatus corresponding to a first node among the plurality of nodes has been changed, the second communication apparatus corresponding to a second node that is adjacent to the first node; and
updating information regarding the first node in the network information using the change notification.
